(19) United States
(12) Patent Application Publication
(10) Pub. No.: US 2022/0204816 A1
(43) Pub. Date: Jun. 30, 2022

(54) Waterproof Cover

(71) Applicant: NITTO DENKO CORPORATION, Osaka (JP)

(72) Inventors: Tamao FUKUSHIMA, Ibaraki-shi, Osaka (JP); Yosuke SUGAYA, Ibaraki-shi, Osaka (JP); Hisae KITAGAWA, Ibaraki-shi, Osaka (JP)

(73) Assignee: NITTO DENKO CORPORATION, Osaka (JP)

(21) Appl. No.: 17/603,462

(22) PCT Filed: Apr. 16, 2020
(86) PCT No.: PCT/JP2020/016693

§ 371 Date: Oct. 13, 2021

(30) Foreign Application Priority Data
Apr. 18, 2019 (JP) 2019-079643

(51) Int. Cl. C09J 7/38; C09J 7/25; C09J 11/08; C09J 11/06

(52) U.S. Cl. CPC C09J 7/385; C09J 7/255; C09J 11/08; C09J 2203/326; C09J 2467/006; C09J 2433/00; C09J 2301/124; C09J 11/06

(57) ABSTRACT

Provided is a waterproof cover having a waterproof membrane, and a PSA sheet laminated peripherally to the waterproof membrane. The PSA sheet comprises a PSA layer bonded to the waterproof membrane. The PSA layer is formed of a PSA having a storage modulus G′ of 53000 Pa or higher at 40° C.

### TECHNICAL FIELD

The present invention relates to a waterproof cover.

The present application claims priority to Japanese Patent Application No. 2019-079843 filed on Apr. 18, 2019; the entire content thereof is incorporated herein by reference.

### BACKGROUND ART

Waterproof membranes may be applied to housings to house water-sensitive articles such as electronic components and precision devices. For instance, a housing of an electronic device having voice functions such as a smartphone and a gaming device typically has openings on acoustic members such as a loudspeaker, a microphone and a buzzer as well as at the corresponding locations. On the openings, waterproof membranes (waterproof acoustic membranes) having acoustic properties (sound transmission) combined with waterproof properties are placed to prevent foreign substances such as water and dust from entering the inside of the housing through the openings. The likes of a housing to house a component that may heat up such as a vehicle lamp and a housing for a home appliance often have an opening to secure breathability (typically, air permeability) between the outside and the inside of the housing. This can level potential pressure differences between the outside and the inside of the housing, or reduce their magnitudes. On the opening, a waterproof membrane (waterproof breathable membrane) having both breathability and waterproof properties is often placed to prevent water from entering the inside of the housing through the opening. Conventional art documents related to waterproof membranes include Patent Documents 1 and 2.

### CITATION LIST

### Patent Literature

[Patent Document 1] Japanese Patent Application Publication No. 2014- 31412
[Patent Document 2] Japanese Patent Application Publication No. 2003- 128831

### SUMMARY OF INVENTION

### Technical Problem

The waterproof membrane is typically placed on the housing opening by fixing the periphery of the waterproof membrane to the circumference of the opening. For instance, it is possible to employ a method such that a waterproof cover having a waterproof membrane peripherally laminated with a PSA sheet is prepared in advance and this is fixed to the circumference of the opening. The waterproof cover is easily handled because the periphery of the waterproof membrane is reinforced with the PSA sheet.

From the standpoint of in proving the appearance and preventing or reducing degradation and alteration of acoustic properties, etc., the waterproof membrane placed on the housing opening is preferably free of wrinkles in the area covering the opening. However, in a waterproof cover having a waterproof membrane peripherally laminated with a PSA sheet, the present inventors have found that even if the waterproof membrane is wrinkle-free initially upon the waterproof cover's preparation or placement on a housing, the waterproof membrane develops wrinkles with aging.

An objective of this invention is thus to provide a waterproof cover whose waterproof membrane is less susceptible to wrinkling with aging. Another related objective is to provide a waterproof casing having such a waterproof cover and an electronic device having the waterproof cover.

### Solution to Problem

This Description provides a waterproof cover having a waterproof membrane and a PSA sheet laminated peripherally to the waterproof membrane. The PSA sheet includes a PSA layer bonded to the waterproof membrane. The PSA layer is formed of a PSA having a storage modulus G′ at 40° C. (or a 40° C. storage modulus G′, hereinafter) of 53000 Pa or higher. According to the waterproof cover in such an embodiment, the displacement (e.g. uneven displacement such as anisotropic shrinkage) of the waterproof membrane relative to the PSA sheet can be reduced, preventing the waterproof membrane from wrinkling with aging.

In some embodiments of the waterproof cover disclosed herein, the PSA is preferably crosslinked with an epoxy-based crosslinking agent. The PSA crosslinked with the epoxy-based crosslinking agent tends to effectively reduce wrinkling of the waterproof membrane with aging.

In some embodiments, the PSA has a gel fraction of 35% or higher. The PSA having a gel fraction of 35% or higher tends to effectively reduce wrinkling of the waterproof membrane with aging.

In some embodiments, as the PSA, an acrylic PSA comprising an acrylic polymer as base polymer can be preferably used. The waterproof cover disclosed herein can be preferably made in an embodiment where the PSA sheet is bonded to the waterproof membrane with an acrylic PSA.

In some embodiments, the PSA may comprise a tackifier. The use of tackifier can enhance the adhesion to the waterproof membrane and further reduce the displacement of the waterproof membrane relative to the PSA sheet. This tends to effectively reduce wrinkling of the waterproof membrane with aging.

In some embodiments, the PSA sheet preferably shows a displacement of 0.4 mm/h or less in a holding power test carried out at 80° C. The PSA sheet showing such holding properties is highly effective in reducing the displacement of the waterproof membrane and is suited for preventing wrinkling with aging.

In the waterproof cover according to a preferable embodiment, the PSA sheet is an adhesively double-faced PSA sheet whose first and second faces are both adhesive, namely a double-faced PSA sheet. With the waterproof cover whose waterproof membrane is peripherally laminated with a double-faced PSA sheet at least on one face, the waterproof cover can be efficiently attached to an adherend, using the adhesiveness of the PSA sheet's reverse side surface (outer adhesive face) opposite to the waterproof membrane-bonding side.

In some embodiments, as the double-faced PSA sheet, it is preferable to use a substrate-supported double-faced PSA sheet having a substrate with first and second faces, the PSA layer as an inner PSA layer placed on the first face, and an outer PSA layer placed on the second face. Such an embodiment using the substrate-supported double-faced PSA sheet can be advantageous in view of the waterproof cover's strength, shape retention, processability, etc. As the substrate, resin film can be preferably used.

In other embodiments, as the double-faced PSA sheet, it is preferable to use a substrate-free PSA sheet formed of the PSA layer. Such an embodiment using the substrate-free PSA sheet can be advantageous in view of the waterproof cover's thickness reduction, flexibility, processability; etc.

This Description provides a waterproof casing having a container (housing) with an opening, and a waterproof cover attached to the container to close the opening. As the waterproof cover, a waterproof cover disclosed herein is used. This helps obtain a waterproof casing whose waterproof membrane covering the opening is free of wrinkles. Such a waterproof casing is preferable in view of the appearance, sealing properties, performance stability, etc., as the opening-covering waterproof membrane is readily prevented from wrinkling with aging.

Such a waterproof casing can be preferably used for housing a water-sensitive article such as an electronic component. This Description thus provides an electronic device having a container with an opening, an electronic component housed in the container, and a waterproof cover attached to the container to close the opening. As the waterproof cover, a waterproof cover disclosed herein is used. Such an electronic device is preferable in view of the appearance, sealing properties, performance stability, etc., as the opening-covering waterproof membrane is readily prevented from wrinkling with aging.

The waterproof casing can be preferably used in an application requiring waterproof properties along with sound transmission and/or breathability between the casings inside and outside. One favorable example of the application is to house an acoustic component. In other words, the waterproof casing disclosed herein can be preferably used as a waterproof casing to house an acoustic component. This Description provides an acoustic instrument comprising a waterproof casing disclosed herein and an acoustic component housed in the waterproof casing.

### BRIEF DESCRIPTION OF DRAWINGS

FIG. 1 shows a perspective diagram schematically illustrating the waterproof cover according to an embodiment.

FIG. 2 shows a cross section along line II-II in FIG. 1.

FIG. 3 shows a cross-sectional diagram schematically illustrating the waterproof cover according to another embodiment.

FIG. 4 shows a schematically illustrated front view of a smartphone having a housing (waterproof casing) equipped with a waterproof cover.

FIG. 5 shows a cross-sectional diagram schematically illustrating the structure of a waterproof cover sample for testing.

### DESCRIPTION OF EMBODIMENTS

Preferred embodiments of the present invention are described below. Matters necessary to practice this invention other than those specifically referred to in this description may be comprehended by a person of ordinary skill in the art based on the instruction regarding implementations of the invention according to this description and the common technical knowledge in the pertinent field. The present invention can be practiced based on the contents disclosed in this description and common technical knowledge in the subject field.

In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent actual accurate sizes or reduction scales.

As used herein, the term “PSA” refers to a material that exists as a soft solid (a viscoelastic material) in a room temperature range and has a property to adhere easily to an adherend with some pressure applied, which may also be referred to as a pressure-sensitive adhesive (PSA). As defined in “Adhesion: Fundamental and Practice” by C. A. Dahlquist (McLaren & Sons (1966), P. 143), PSA referred to herein may generally be a material that has a property satisfying complex tensile modulus E*(1 Hz)<10⁷ dyne/cm² (typically, a material that exhibits the described characteristics at 25° C.).

As used herein, the “base polymer” of PSA refers to a main component of a rubbery polymer (polymer showing rubber elasticity in the room temperature range) contained in the PSA layer. Further, as used herein, the “main component” means a component contained in an amount of more than 50% by weight, unless specifically stated otherwise.

As used herein, the term “(meth)acryloyl” is meant to be inclusive of acryloyl and methacryloyl. Likewise, “(meth)acrylate” means acrylate and methacrylate, and “(meth)acryl” is meant to be inclusive of acryl and methacryl respectively.

As used herein, the term “acrylic polymer” refers to a polymerized product including a monomer unit derived from a monomer having at least one (meth)acryloyl group in a molecule as a monomer unit constituting the polymer. Hereinafter, a monomer having at least one (meth)acryloyl group in a molecule can be also referred to as “acrylic monomer”. Therefore, the acrylic polymer in this description is defined as a polymer including a monomer unit derived from an acrylic monomer. A typical example of the acrylic polymer is a polymerized product of monomers including an acrylic monomer in an amount of more than 50% by weight. In a preferred embodiment, the amount of the acrylic monomer in the monomers can be about 70% by weight or more (e.g. about 90% by weight or more).

### <Constitutional Examples of Waterproof Cover>

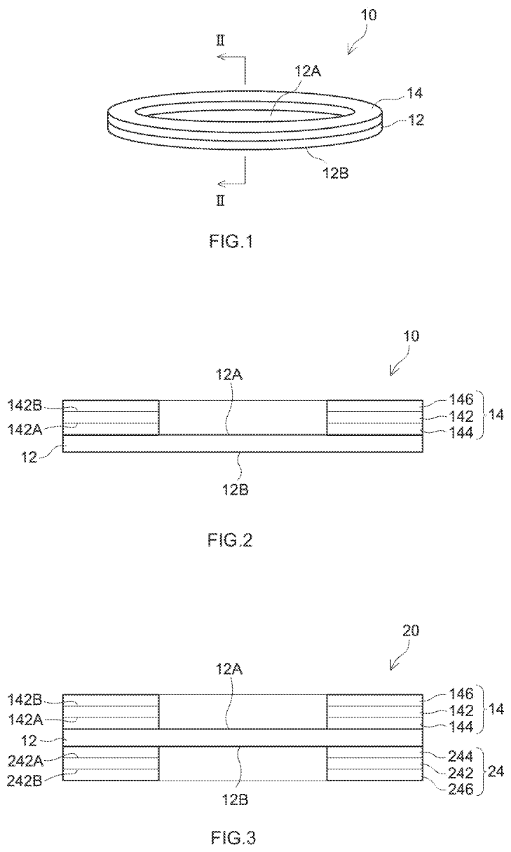

FIG. 1 shows a perspective diagram schematically illustrating the waterproof cover according to an embodiment and FIG. 2 shows a cross section along line II-II therein. Waterproof cover 10 in this embodiment has a waterproof membrane 12 and a PSA sheet 14. Waterproof membrane 12 may serve as a waterproof acoustic membrane and/or as a waterproof breathable membrane. Waterproof cover 10 and waterproof membrane 12 have round shapes in a planar view. In the planar view, PSA sheet 14 has an annular (ring) shape and laminated peripherally on one (first) face 12A of waterproof membrane 12. PSA sheet 14 is constituted as a substrate-supported double-faced PSA sheet comprising a substrate 142 as well as a first PSA layer (inner PSA layer) 144 and a second PSA layer (outer PSA layer) 146 placed on the first face (waterproof membrane side surface) 142A and the second face (outer surface) 142B, respectively. In this embodiment, substrate 142, the first and second PSA layers 144 and 146 all have the same shape in the planar view. PSA sheet 14 is bonded to waterproof membrane 12 with the first PSA layer 144. The area inside PSA sheet 14 (the area surrounded by PSA sheet 14) is the effective area of waterproof membrane 12 (e.g. the acoustic region in a waterproof acoustic membrane, the breathable area in a waterproof breathable membrane).

Waterproof cover 10 shown in FIG. 1 can be fixed to an adherend by press-bonding the second PSA layer 146 to the adherend. For instance, with respect to a container (adherend) having an opening, the second PSA layer 146 can be press-bonded to the circumference of the opening to constitute a waterproof casing with waterproof cover 10 attached to the opening. In the embodiment shown in FIG. 1, a substrate-supported double-faced PSA sheet is used as PSA sheet 14 bonded with its PSA layer to the periphery of waterproof cover 10; however, PSA sheet 14 can be a substrate-free PSA sheet formed of a PSA layer (i.e. a double-faced PSA sheet free of a substrate). The waterproof cover in this embodiment can be attached to an adherend, for instance, by press-bonding the reverse face of the waterproof membrane-bonding PSA layer onto the adherend. Alternatively, PSA sheet 14 can be a substrate-supported single-faced PSA sheet having the first PSA layer 144 on the first face 142A side of substrate 142 while having no PSA layer on the second face 142B of substrate 142. The waterproof cover in this embodiment can be attached to the adherend by bonding with adhesive such as epoxy-based adhesive and epoxy-modified polyimide-based adhesive, welding such as heat welding and laser welding, or mechanical means such as pinching and crimping.

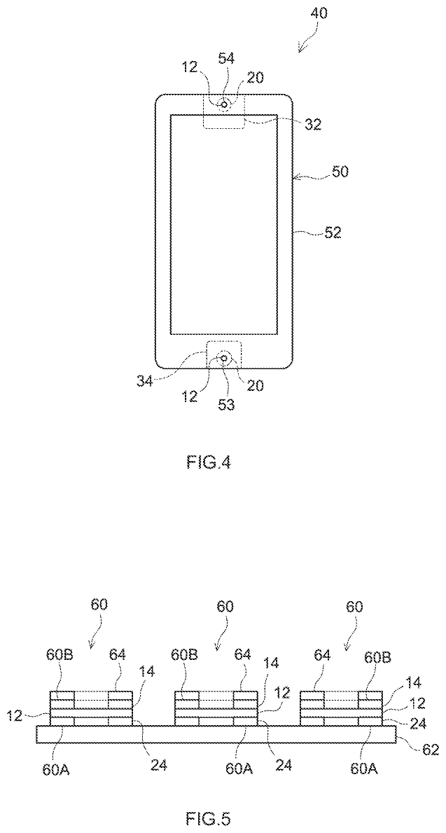

FIG. 3 shows a cross-sectional diagram schematically illustrating the waterproof cover according to another embodiment. Waterproof cover 20 in this embodiment has generally the same constitution as waterproof cover 10 shown in FIG. 1 except that it further has a PSA sheet 24 laminated peripherally on the other (second) face 12B of waterproof membrane 12 in addition to PSA sheet 14 laminated peripherally on the first face 12A of waterproof membrane 12. PSA sheet 24 is constituted as a substrate-supported double-faced PSA sheet comprising a substrate 242 as well as first and second PSA layers 244 and 246 placed on the first and second faces 242A and 242B, respectively. In this embodiment, substrate 242, the first and second PSA layers 244 and 246 all have the same shape in a planar view. PSA sheets 14 and 24 also have the same shape in the planar view. PSA sheet 24 is bonded to waterproof membrane 12 with the first PSA layer 244. Waterproof cover 20 shown in FIG. 2 can be used by press-bonding the second PSA layer 146 on the first face of waterproof membrane 12 onto an adherend (e.g. the inner wall around an opening of a container) and press-bonding the second PSA layer 246 on the second face of waterproof membrane 12 onto another adherend (e.g. a component constituting a sound output or input member such as a speaker or microphone). Similar PSA sheet 14, PSA sheet 24 can be a substrate-free PSA sheet or a substrate-supported single-faced PSA sheet.

In a planar view, the waterproof membrane in the waterproof cover disclosed herein is not limited to a round shape as the one shown in FIG. 1 and can have a different shape, with examples including ovals, rectangles, non-rectangular polygons (e.g. triangles) and other different shapes. The PSA sheet laminated peripherally to the waterproof membrane typically has an annular (closed-ring) shape, but is not limited to this. For instance, it may have an open ring shape or a ring shape with multiple arc segments.

In a preferable embodiment, the outer edge of the PSA sheet in the planar view of the waterproof cover matches the outer edge of the waterproof membrane, for instance, similar to waterproof cover 10 shown in FIG. 1. Alternatively, the PSA sheet's outer edge may be partially or entirely located inside or outside the waterproof membrane's outer edge. For instance, part of the PSA sheet can extend in an outer direction from the waterproof membrane's outer edge, forming a tab. In this case, from the standpoint of the tab's strength and ease of formation, it is preferable to use, as the PSA sheet, a substrate-supported PSA sheet having a PSA layer on one or each face of a substrate (e.g. a resin film). The waterproof cover with a tab formed on the PSA sheet can be handled by holding the tab; and therefore, it is highly workable when applying the waterproof cover to a housing, etc. The substrate-supported PSA sheet may also be constituted so that the tab portion has no PSA layer on either face.

### <Waterproof Membrane>

The waterproof membrane used in the waterproof cover disclosed herein is not particularly limited. For instance, various kinds of waterproof membranes known to be usable as waterproof acoustic membranes or waterproof breathable membranes can be used as the waterproof membrane of the waterproof cover disclosed herein.

In some embodiments, the waterproof membrane can be formed from one, two or more kinds of materials selected among resin materials including fluororesins such as polytetrafluoroethylene (PTFE), polyvinylidene fluoride (PVDF), tetrafluoroethylene-hexafluoropropylene copolymer (FEP), ethylene-tetrafluoroethylene copolymer (ETFE) and ethylene-chlorotrifluoroethylene copolymer (ECTFE); polyesters such as polyethylene terephthalate and polybutylene terephthalate; polycarbonates; polyolefins such as polyethylene and polypropylene; polysulfones; polyimides; polyetherimide, polyamideimide; as well as elastomers such as silicone rubber; and the like. The waterproof membrane can be a monolayer membrane or a multilayer membrane comprising several laminated layers.

One favorable example of the waterproof membrane formed from a resin material is a waterproof membrane formed from PTFE. Such a waterproof membrane has a well-balanced weight and strength as well as excellent heat resistance. The waterproof membrane's heat resistance can be advantageous, for instance, when the waterproof cover is expected to be subjected to heat treatment (e.g. reflow soldering) after attached to an adherend (e.g. a waterproof casing or the like that may be used for an acoustic component or electronic device).

The waterproof membrane can be non-porous or porous. Here, the term “non-porous” means that there are no or very few micropores communicating through the membrane's first and second principal planes. For instance, a membrane whose air permeability is greater than 10000 s/100 mL expressed in Gurley number can be judged non-porous.

When the waterproof membrane is porous, the waterproof membrane's air permeability can be selected in a certain range that gives desirable waterproof properties and is not particularly limited. For instance, as the waterproof membrane of the waterproof cover disclosed herein, it is preferable to use a porous membrane having an air permeability in the range between 0.1 s/100 mL and 1000 s/100 mL. The porous membrane's air permeability can be, for instance, 5000 s/100 mL or lower, 1000 s/100 mL or lower, or even 300 s/100 mL or lower. With a porous membrane having a lower air permeability (Gurley number), superior sound transmission is likely to be obtained. In some embodiments, the porous membrane may have an air permeability of 200 s/100 mL or lower, or even 100 s/100 mL or lower. From the standpoint of the strength and handling properties, in some embodiments, the porous membrane's air permeability can be, for instance, 0.5 s/100 mL or higher, 1 s/100 mL or higher, or even 5 s/100 mL or higher. The art disclosed herein can be preferably implemented in an embodiment using, as the waterproof membrane, a porous membrane having an air permeability of, for instance, 10 s/100 mL or higher, 20 s/100 mL or higher, or 40 s/100 mL or higher. The “Gurley number” here means a value obtained by Method B (Gurley method) among the permeability test methods specified in JIS L 1096(2010).

In the embodiment where the waterproof membrane is a waterproof acoustic membrane, sound can be transmitted through vibrations of the waterproof membrane; and therefore, for the sake of sound transmission, it is not essential that the waterproof membrane has air permeability. The waterproof membrane being non-porous is an advantage as when attached to a housing, water vapor can be prevented from entering the inside of the housing through the waterproof membrane. In addition, a non-porous membrane has typically superior water resistance than a porous membrane. On the other hand, suitable air permeability is sometimes desirable in a waterproof acoustic membrane. For instance, when the housing's internal temperature fluctuates relatively largely, suitable air permeability can be effective in preventing condensation inside the housing. In this case, the waterproof membrane is desirably porous. Such a porous waterproof membrane having air permeability can be thought as a waterproof breathable membrane as well.

In some embodiments, the waterproof membrane formed from a resin material can have a thickness in the range of, for instance, 1 μm or greater and 25 μm or less, 1 μm or greater and 20 μm or less, or even 3 μm or greater and 10 μm or less. When the surface density and/or thickness are adjusted to suitable ranges, water resistance and sound transmission can be readily combined in the waterproof membrane. The surface density refers to the membrane's weight per unit area and is determined by dividing the membrane's weight by its area (area of principal plane). The waterproof membrane may have a surface density in the range of, for instance, 1 g/m² to 30 g/m², 1 g/m² to 25 g/m², or even 5 g/m² to 20 g/m².

When the waterproof membrane is formed of an elastomer, the elastomer can be selected among known rubber-like elastic bodies and thermoplastic elastomers. The rubber-like elastic body is not particularly limited as long as the material has rubber elasticity. Specific examples of rubber-like elastic bodies include silicone rubber, ethylene-propylene-diene monomer rubber (EPDM), acrylic rubber, urethane rubber and natural rubber. From the standpoint of the heat resistance, chemical resistance, etc., it is desirable to use silicone rubber in particular. Examples of thermoplastic elastomers include styrene-based, olefin-based, urethane-based and ester-based thermoplastic elastomers. To obtain superior sound transmission, in some embodiments, it is preferable to use a rubber-like elastic body (e.g. silicone rubber) having a type A hardness in the range of 20 or higher and 80 or lower based on JIS K 6235.

The waterproof membrane formed of an elastomer can have a thickness in the range of, for instance, 10 μm or greater and 1.50 μm or less. When the thickness is in this range, good sound transmission is likely to be obtained. In some embodiments, the waterproof membrane's thickness can be 20 μm or greater, 30 μm or greater and 1.30 μm or less, or 110 μm or less. The waterproof membrane can be produced by a method where a liquid material is extruded in a thin layer on a separable substrate by discharging means such as a die; a method where a liquid material is casted on a separable substrate and then spread thin with an applicator, wire bar or knife coater; or like method. In these methods, the waterproof membrane can be further adjusted to a desirable thickness by machining, etc.

When the waterproof membrane is porous, it may have a mean pore diameter in the range of, for instance, 0.01 μm or greater and 1 μm or less. The waterproof membrane's porosity is in the range of, for instance, possibly 5% or higher and 95% or lower, preferably 10% or higher and 80% or lower, or more preferably 20% or higher and 50% or lower. When the mean pore diameter and/or porosity are adjusted to suitable ranges, sound transmission and water resistance are readily combined in the waterproof membrane. The mean porosity can be determined by a method based on ASTM F316- 86. The porosity can be determined by substituting the waterproof membrane's weight, volume and true density into the equation shown below. For instance, when the waterproof membrane is formed of PTFE, 2.18 g/cm³ is used as the true density value.

Porosity (%)={1−(weight in g÷(thickness in cm×area in cm²×true density in g/cm³))}×100

When the waterproof membrane is porous, the waterproof cover disclosed herein may include a breathable support member laminated to the waterproof membrane. The breathable support member serves to support the waterproof membrane. The breathable support member works effectively when layered over an area that includes a region inside the PSA sheet-laminated area in the waterproof membrane. The breathable support member may also be layered over the entire range of the waterproof membrane. The breathable support member can be a woven fabric, nonwoven fabric, mesh, net, sponge, foam or porous body formed of a metal, a resin or a composite material thereof. Examples of the resin include polyolefins, polyester, polyamides, aramids and fluororesins. Examples of the polyolefins include super high density polyethylenes. The breathable support member can be laminated to the waterproof membrane by a method such as hot lamination, thermal welding, ultrasonic welding, and bonding with PSA or adhesive.

The waterproof membrane can be colored. In other words, the waterproof membrane may include a colorant such as a pigment and a dye. Examples of the dye include azo-based dyes and oil colors. One example of preferable colorants is carbon black. For instance, when carbon black is included, the waterproof membrane may be colored gray or black. Here, being colored gray or black means that it includes a black-coloring colorant. In general, based on the degree of blackness specified in JIS Z 8721(1993), 1 to 4 is considered black, 5 to 8 grays, and 9 or higher white. The waterproof membrane may be subjected to known treatment such as oleophobic treatment and adhesion enhancement. These treatments can be applied in combination as necessary

The oleophobic treatment can be carried out, for instance, by applying an oleophobic treatment solution to the waterproof membrane and allowing it to dry. The method for applying the oleophobic treatment solution is not particularly limited. Examples of possible means include spraying, spin coating, dipping, and roll coating. The oil repellent (oleophobic agent) is not particularly limited. A fluorine-based oil repellent is preferable. The fluorine-based oil repellent is preferably at least one species selected from the group consisting of an acrylic polymer having a fluorine-containing side chain, a urethane polymer having a fluorine-containing side chain, and a silicone-based polymer having a fluorine-containing side chain. As the fluorine-based oil repellent, a commercial product can be used. For instance, it is possible to use UNIDYNE® series available from Daikin Industries, Ltd.; X-70- 029C and X-70- 043 available from Shin-Etsu Chemical Co., Ltd,; SF COAT® series (e.g. SIF-200) available from AGC Seimi Chemicals Co., Ltd.; etc. Examples of a fluorinated silicone-based polymer oil repellent include KP-801M available from Shin-Etsu Chemical Co., Ltd.

Described next is one example of the method for producing a waterproof membrane formed of PTFE.

Firstly, a dispersion of PTFE powder (a PTFE dispersion) is applied to a substrate to form a coating film. The dispersion may include a colorant. The substrate can be formed from a heat-resistant material such as heat-resistant plastics (polyimide, polyether ether ketone, etc.), metals and ceramics. The substrate's form is not particularly limited. For instance, it can be in sheet form, tube form or bar form. The dispersion can be applied to the substrate by a method where the substrate is immersed in and removed from the dispersion, a method where the dispersion is sprayed to the substrate, a method where the dispersion is brush-coated on the substrate, or like method. To improve the dispersion's wettability to the substrate surface, the dispersion may include a surfactant such as a silicone-based surfactant and a fluorine-based surfactant.

The coating film is then heated. This removes the dispersion medium from the coating film and binds PTFE particles together. After heated, a PTFE film (typically non-porous) is formed on one or each face of the substrate. As the method for heating the waterproof membrane, for instance, a two-step heating method can be employed, where in the first step, the coating film is heated at a temperature capable of vaporizing the dispersion medium to remove the dispersion medium; and then in the second step, the coating film is heated (sintered) at a temperature at or above the melting point of PTFE to bind PTFE particles together. When the dispersion medium is water, by heating the coating film, for instance, at 90° C. to 150° C. in the first step and at 350° C. to 400° C. in the second step, a PTFE film can be formed on the substrate. Alternatively, a one-step heating method can also be employed, where the coating film is heated at a temperature at or above the melting point of PTFE for a certain time period.

A PTFE film having a desirable thickness may be formed by repeating the step of applying the dispersion to the substrate to form a coating film and the step of heating the coating film. The coating film formation step and the coating film heating step can be carried out alternately; or, for instance, the coating film formation step can be repeated twice and followed by the coating film heating step.

The PTFE film (thin resin film) is then separated from the substrate. This is further followed by a step of rolling the PTFE film in MD (in the length direction) and a step of stretching the PTFE film in TD (in the width direction) carried out in this order. By this, a porous waterproof membrane is obtained. The step of stretching the PTFE film in TD and the step of rolling the PTFE film in MD can be carried out in this order as well. When the rolling step is carried out after the stretching step, micropores formed by TD stretching collapse when rolled and a nonporous waterproof membrane is obtained. In the process of forming the nonporous or porous membrane, the PTFE film can be further stretched in MD. Instead of the step of stretching the PTFE film in TD, a step of rolling the PTFE film in TD can be carried out as well. The rolling ratio and the stretch ratio are suitably set in view of the balance between waterproof properties and sound transmission in a waterproof acoustic membrane or between waterproof properties and breathability in a waterproof breathable membrane. The MD rolling ratio value can be, for instance, 1.25 to 3.5. The TD stretch ratio value can be, for instance, 1.25 to 3.5. The MD stretch ratio value can be, for instance, 1.25 to 3.5. The TD rolling ratio value can be, for instance, 1.25 to 3.5.

As the method for rolling the PTFE film, a known method can be employed, for instance, press-rolling and roller rolling. Press-rolling is hot plate rolling where the PTFE film is placed between a pair of heating plates and rolled while being heated. In roller rolling, for instance, the PTFE film is fed through a pair of rollers (of which one or each is heated), whereby the PTFE film is rolled while being heated. Between the two rolling methods, roller rolling is more preferable because the PTFE's orientation is easily controlled and a belt of PTFE film can be continuously rolled. Rolling can be carried out two or more times as necessary. The rolling direction for this can be the same or different in the respective rounds.

The heating temperature when rolling the PTFE film can be, for instance, 80° C. to 200° C. The PTFE film can also be heated while being stretched in the step of stretching the PTFE film. The heating temperature when stretching the PTFE film can be, for instance, 100° C. to 400° C. The temperature can be the surrounding temperature of the PTFE film in the rolling machine or the stretching machine. Alternatively, the PTFE film can be stretched at a temperature near room temperature (e.g. at 10° C. to 60° C.).

After the PTFE film is separated from the substrate, it may be subjected to a treatment to modify at least part of the PTFE film surface. Such a treatment can be carried out to enhance the adhesion between the waterproof membrane and other material (e.g. PSA). The surface modification treatment (adhesion enhancement) can be PTFE modification, for instance, chemical treatment and sputter etching. The surface modification treatment can be carried out before the rolling and stretching steps or after these steps.

The chemical treatment can be, for instance, a treatment using an alkali metal such as sodium (alkali metal treatment). In an alkali metal treatment, for instance, a sodium metal-containing etching solution is allowed to contact the PTFE film to extract fluorine atoms to form functional groups in areas in contact with the etching solution in the PTFE film, thereby enhancing the adhesion. To allow contact between the etching solution and the PTFE film, the PTFE film can be immersed in the etching solution. The etching solution can be, for instance, a sodium metal/liquid ammonia solution obtained by dissolving sodium metal in liquid ammonia, or a sodium metal/naphthalene solution obtained by dissolving sodium metal in a naphthalene solution. Between the two solutions, the sodium metal/naphthalene solution is desirable because it can be easily controlled and handled while the treatment can be carried out without lowering the temperature to around −50° C.

In sputter etching, the PTFE film surface is bombarded with energy particles originating in gas. In areas bombarded with the particles in the PTFE film, atoms or molecules present on the PTFE film surface are released to form functional groups, whereby adhesion is enhanced. Sputter etching can be carried out, for instance, by placing the PTFE film in a chamber, reducing the pressure inside the chamber, and then applying a high-frequency voltage while introducing an atmospheric gas. The atmospheric gas is, for instance, at least one species selected from the group consisting of inert gases (helium, neon, argon, krypton, etc.), nitrogen gas and oxygen gas. The frequency of the applied high-frequency voltage is, for instance, 1 MHz to 100 MHz, or desirably 5 MHz to 50 MHz. The pressure inside the chamber when applying the high-frequency voltage is, for instance, 0.05 Pa to 200 Pa, or desirably 1 Pa to 100 Pa. The sputter etching energy (the product of treatment time and applied electric power) is, for instance, 1 J/cm² to 1000 J/cm², or desirably 2 J/cm² to 200 J/cm².

### <PSA Sheet>

The waterproof cover disclosed herein is characterized by a PSA sheet laminated peripherally to a waterproof membrane, with the PSA sheet and the waterproof membrane bonded together with a PSA layer formed of a PSA having a 40° C. storage modulus G′ of 53000 Pa or higher. With the waterproof cover in such an embodiment, the waterproof membrane can be prevented from wrinkling with aging. Hereinafter, the PSA layer bonding the PSA sheet and the waterproof membrane together may be referred to as a “membrane-bonding PSA layer” and the PSA forming the membrane-bonding PSA layer as a “membrane-bonding PSA.”

For instance, how these effects are obtained can be considered as follows: in particular, in the waterproof membrane laminated with the PSA sheet, internal stress may exist due to handling during production of the waterproof membrane or lamination with the PSA sheet. For instance, in the waterproof membrane obtained by MD rolling and TD stretching as described above, anisotropic internal stress may exist due to the rolling and stretching. When the waterproof cover is prepared by laminating a PSA sheet to a waterproof membrane having internal stress, the post-lamination waterproof membrane may deform (typically shrink) to reduce the internal stress, leading to displacement of the waterproof membrane relative to the PSA sheet. Such displacement does not develop evenly in typical. Instead, it develops unevenly due to localized stress concentration, the anisotropy of the internal stress, etc. Such uneven displacement may cause wrinkling of the waterproof membrane with aging after the waterproof cover is produced. The PSA having an aforementioned storage modulus G′ is highly resistant to deformation in shear directions (in-plane directions of the waterproof membrane). Thus, when the PSA layer bonded to the waterproof membrane is formed of a PSA (membrane-bonding PSA) having such a storage modulus G′, it is presumed that the relative displacement between the waterproof membrane and the PSA sheet is inhibited to prevent the waterproof membrane from wrinkling with aging. It is noted, however, that it is not limited to this reason.

The waterproof cover disclosed herein may be in an embodiment as in, for instance, waterproof cover 10 shown in FIG. 1, wherein the PSA sheet is laminated peripherally on one (first) face of the waterproof membrane; or it may be in an embodiment as in, for instance, waterproof cover 20 shown in FIG. 3, wherein PSA sheets are laminated peripherally on the first and second faces of the waterproof membrane. When the PSA forming the PSA layer bonded to the surface of at least one face of the waterproof membrane has an aforementioned storage modulus G′, the effect to prevent the waterproof membrane from wrinkling with aging can be obtained. Accordingly, in the waterproof cover in the embodiment where PSA sheets are laminated peripherally on the first and second faces of the waterproof membrane, it is satisfactory that the PSA forming the PSA layer bonded to the first face has a 40° C. storage modulus G′ of 53000 Pa or higher; and no particular limitations are imposed on the 40° C. storage modulus G′ of the PSA forming the PSA layer bonded to the second face. In a preferable embodiment, each of the PSA layers bonded to the first and second faces has a 40° C. storage modulus G′ of 53000 Pa or higher. Such an embodiment can bring about greater effect to prevent the waterproof membrane from wrinkling with aging.

In the art disclosed herein, the PSA's 40° C. storage modulus G′ (25° C.) and 80° C. storage modulus G′ (storage modulus at 80° C.) described later can be determined by dynamic elastic modulus measurement. In particular, an approximately 2 mm thick PSA layer is prepared with the PSA subject to measurement. From this PSA layer, a disc of 7.9 mm diameter is punched out to prepare a specimen. The specimen is fixed between parallel plates. With a rheometer (e.g. ARES available from TA Instruments or a comparable system), dynamic elastic modulus measurement is carried out to determine storage moduli G′ at the respective temperatures.
Measurement mode: shear mode
Temperature range: −70° C. to 150° C.
Heating rate: 5° C./min
Measurement frequency: 1 Hz

The same measurement method is also used in the working examples described later. The PSA layer can be formed by applying the corresponding PSA composition to a release liner and allowing it to dry or cure. The PSA layer may also be formed by layering multiple PSA layers.

In some embodiments of the waterproof cover disclosed herein, the membrane-bonding PSA may have a 40° C. storage modulus G′ of, for instance, 60000 Pa or higher, 70000 Pa or higher, 85000 Pa or higher, 100000 Pa or higher, or even 110000 Pa or higher. An increase in 40° C. storage modulus G′ tends to enhance the effect to prevent displacement of the waterproof membrane relative to the PSA sheet. The maximum 40° C. storage modulus G′ is not particularly limited. From the standpoint of the adhesion to waterproof membranes (especially porous waterproof membranes), in some embodiments, the 40° C. storage modulus G′ can be, for instance, 500000 Pa or lower, 300000 Pa or lower, 200000 Pa or lower, or even 150000 Pa or lower.

The waterproof cover disclosed herein can be preferably made in an embodiment where the membrane-bonding PSA has an 80° C. storage modulus G′ of, for instance, 20000 Pa or higher. Such a membrane-bonding PSA can favorably prevent displacement of the waterproof membrane even when exposed to a high temperature while being stored or used, and effectively inhibit wrinkling. In some embodiments, the 80° C. storage modulus G′ can be, for instance, 30000 Pa or higher, 35000 Pa or higher, or even 40000 Pa or higher. The maximum 80° C. storage modulus G′ is not particularly limited. From the standpoint of readily obtaining good adhesive strength to waterproof membranes (especially porous waterproof membranes), in some embodiments, the 80° C. storage modulus G′ can be, for instance, 200000 Pa or lower, 150000 Pa or lower, 100000 Pa or lower, or even 800000 Pa or lower.

The PSA's storage moduli G′ at 40° C. and 80° C. can be adjusted through, for instance, the base polymer's composition and molecular weight, use of crosslinking agent and tackifier as well as selections of their types and amounts used if any, etc. Based on the content of this Description and technical common knowledge, it is possible for a skilled person to perceive how to obtain a PSA that exhibits preferable storage moduli G′ disclosed herein.

### (PSA)

No particular limitations are imposed on the type of PSA forming the PSA layer in the waterproof cover disclosed herein. For example, the PSA layer may be constituted, comprising one, two or more species of PSA selected among various known species of PSA, such as an acrylic PSA, rubber-based PSA (natural rubber-based, synthetic rubber-based, their mixture-based, etc.), silicone-based PSA, polyester-based PSA, urethane-based PSA, polyether-based PSA, polyamide-based PSA, fluorine-based PSA, etc. Herein, the acrylic PSA refers to a PSA comprising an acrylic polymer as the base polymer. The same applies to the rubber-based PSA and other PSA.

In some embodiments, it is preferable to use an acrylic PSA comprising an acrylic polymer as the base polymer. The acrylic PSA is likely to have a preferable 40° C. storage modulus G′ according to this Description, and the crosslinking degree and gel fraction can be easily adjusted as well. Accordingly, it is favorable as a membrane-bonding PSA for the waterproof cover disclosed herein. The following primarily describes about acrylic PSA; however, the PSA forming the waterproof cover's PSA layer disclosed herein is not limited to the acrylic PSA.

### (Acrylic Polymer)

The acrylic polymer as the base polymer of acrylic PSA is preferably a polymer of monomers that include an alkyl (meth)acrylate as the main monomer (primary monomer) and may further include, as necessary, a secondary monomer copolymerizable with the main monomer. Here, the main monomer means the main component among the monomers constituting the acrylic polymer, that is, a component contained among the monomers in an amount of more than 50% by weight.

For example, a compound represented by the following formula (1) can be advantageously used as the alkyl (meth)acrylate.

CH₂═C(R¹)COOR² (1)

Here, R¹ in the formula (1) is a hydrogen atom or a methyl group. R² is an acyclic alkyl group having 1 to 20 carbon atoms (hereinafter, such a range of the number of carbon atoms may be indicated as “C₁₋₂₀”). From the standpoint of the ease of adjusting the adhesive properties, etc., an alkyl (meth)acrylate wherein R² is a C₁₋₁₄ acyclic alkyl group is preferable, and an alkyl (meth)acrylate wherein R² is a C₁₋₁₀ acyclic alkyl group is more preferable.

Specific examples of the alkyl (meth)acrylate having a C₁₋₂₀ acyclic alkyl group for R¹² include, but are not limited to, methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (methacrylate, isopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These alkyl (meth)acrylates can be used singly as one species or in a combination of two or more species. Preferable examples of the alkyl (meth)acrylate include n-butyl acrylate (RA) and 2-ethylhexyl acrylate (2ERA).

Typically, the ratio of the alkyl (meth)acrylate in the monomers is more than 50% by weight, for example, possibly 70% by weight or higher, 85% by weight or higher, or even 90% by weight or higher. From the standpoint of facilitating formation of a suitably cohesive PSA layer, the ratio of alkyl (meth)acrylate in the monomers is possibly lower than 100% by weight, usually suitably 99.5% by weight or lower, also possibly 98% by weight or lower, or even lower than 97% by weight.

The art disclosed herein can be preferably implemented in an embodiment in which the monomers include at least 50% C₁₋₄ alkyl (meth)acrylate by weight. According to such an acrylic polymer, the resulting PSA layer tends to have higher resistance to deformation in shear directions as compared with an acrylic polymer whose main monomer is a (meth)acrylate having an alkyl group having 5 or more carbon atoms at the ester end. In some embodiments, the ratio of C₁₋₄ alkyl (meth)acrylate in the monomers can be, for instance, 70% by weight or higher, 85% by weight or higher, or even 90% by weight or higher.

The art disclosed herein can be preferably implemented out in an embodiment in which the monomers include at least 50% (e.g. at least 70%, at least 75%, at least 85%, or even at least 90%) C₂₋₄ alkyl acrylate by weight. Specific examples of the C₂₋₄ alkyl acrylate include ethyl acrylate, propyl acrylate, isopropyl acrylate, n-butyl acrylate (BA), isobutyl acrylate, s-butyl acrylate, and t-butyl acrylate. The C₂₋₄ alkyl acrylates can be used singly as one species or in a combination of two or more species. In a particularly preferable embodiment, the monomers include more than 50% (e.g. at least 70%, at least 75%, at least 85%, or even at least 90%) BA by weight. On the other hand, from the standpoint of facilitating formation of a suitably cohesive PSA layer, the ratio of C₁₋₄ alkyl (meth)acrylate in the monomers is usually suitably 99.5% by weight or lower, or possibly 98% by weight or lower (e.g. lower than 97% by weight).

The secondary monomer copolymerizable with the alkyl (meth)acrylate as the main monomer can be useful for introducing a crosslinking point into the acrylic polymer or for increasing the cohesiveness of the acrylic polymer. The secondary monomer can also be useful for adjusting the storage elasticity G′. For example, the following functional group-containing monomers can be used singly as one species or in a combination of two or more species as the secondary monomer.

Carboxy group-containing monomers: for example, ethylenically unsaturated monocarboxylic acids such as acrylic acid, methacrylic acid, carboxyethyl (meth)acrylate, carboxypentyl (meth)acrylate, crotonic acid, and isocrotonic acid; and ethylenically unsaturated dicarboxylic acids such as maleic acid, itaconic acid, citraconic acid and anhydrides thereof (maleic anhydride, itaconic anhydride, and the like).

Hydroxyl group-containing monomers: for example, hydroxyalkyl (meth)acrylates such as 2-hydroxyethyl (meth)acrylate, 2-hydroxypropyl (meth)acrylate, 3-hydroxypropyl (meth)acrylate, and 4-hydroxybutyl (meth)acrylate; unsaturated alcohols such as vinyl alcohol and allyl alcohol; and polypropylene glycol mono (meth)acrylate.

Amide group-containing monomers: for example, (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide, and N-butoxymethyl (meth)acrylamide.

Amino group-containing monomers: for example, aminoethyl (meth)acrylate, N,N-dimethylaminoethyl (meth)acrylate, and t-butylaminoethyl (meth)acrylate.

Monomers having an epoxy group: for example, glycidyl (meth)acrylate, methylglycidyl (meth)acrylate, and allyl glycidyl ether.

Cyano group-containing monomers: for example, acrylonitrile and methacrylonitrile.

Keto group-containing monomers: for example, diacetone (meth)acrylamide, diacetone (meth)acrylate, vinyl methyl ketone, vinyl ethyl ketone, allyl acetoacetate, and vinyl acetoacetate.

Monomers having a nitrogen atom-containing ring: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam, and N-(meth)acryloylmorpholine.

Alkoxysilyl group-containing monomers: for example, 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldiethoxysilane.

When the monomers include a functional group-containing monomer as those described above, the amount of the functional group-containing monomer in the monomers is not particularly limited. From the standpoint of suitably obtaining the effect of using the factional group-containing monomer, the amount of the functional group-containing monomer in the monomers is, for example, possibly 0.05% by weight or more, usually suitably 0.1% by weight or more, also possibly 0.2% by weight or more, 0.5% by weight or more, or even 1% by weight or more. From the standpoint of facilitating the balance of adhesive properties, the amount of the functional group-containing monomer in the monomers is usually suitably 40% by weight or less, preferably 20% by weight or less, possibly 10% by weight or less, or even 7% by weight or less.

In some embodiments, the monomers preferably include at least a carboxy group-containing monomer as the functional group-containing monomer. The carboxy group-containing monomer content of the monomers help obtain a PSA layer highly resistant to deformation in shear directions. These carboxy group-containing monomers can be used singly as one species or in a combination of two species. Among them, preferable carboxy group-containing monomers include acrylic acid (AA) and methacrylic acid (MAA). AA is particularly preferable.

When using a carboxy group-containing monomer as the functional group-containing monomer, of the monomers, the carboxy group-containing monomer is used in an amount of, for instance, possibly 0.2% by weight or greater (typically 0.5% by weight or greater) usually suitably 1. % by weight or greater, also possibly 2% by weight or greater, or even 3% by weight or greater. With more than 3% carboxy group-containing monomer content by weight, greater effect (e.g. effect to enhance the resistance to deformation in shear directions) can be obtained and the resulting PSA sheet may have an excellent ability to prevent displacement of the waterproof membrane. From such a standpoint, in an embodiment, of the monomers, the carboxy group-containing monomer content can be 3.2% by weight or higher, 3.5% by weight or higher, 4% by weight or higher, 4.5% by weight or higher, or even 4.8% by weight or higher. The art disclosed herein can be preferably implemented in an embodiment using a PSA whose carboxy group-containing monomer content is 5% by weight or more, or 8% by weight or more of the monomers. The maximum carboxy group-containing monomer content is not particularly limited. From the standpoint of increasing the PSA's hydrophobicity, in some embodiments, the carboxy group-containing monomer content of the monomers can be, for instance, 15% by weight or lower, or even 12% by weight or lower. The art disclosed herein can be preferably implemented in an embodiment using a PSA whose carboxy group-containing monomer content can be 10% by weight or less, 7% by weight or less, or 6% by weight or less of the monomers.

In some embodiments, the monomers are essentially free of a hydroxy group-containing monomer. Here, that the monomers are essentially free of a hydroxy group-containing monomer means that a hydroxy group-containing monomer is not used at least intentionally, allowing an embodiment of the monomers completely free of a hydroxy group-containing monomer as well as an embodiment unintentionally including, for instance, approximately up to 0.02% (typically up to 0.01%) hydroxy group-containing monomer by weight. For instance, the art disclosed herein can be preferably implemented in an embodiment where the monomers include a carboxy group-containing monomer and is essentially free of a hydroxy group-containing monomer.

In some embodiments, the monomers include a carboxy group-containing monomer and are essentially free of other functional group-containing monomers (i.e. non-carboxy group-containing monomers). Here, that the monomers are essentially free of other functional group-containing monomers means that other functional group-containing monomers are not used at least intentionally, allowing an embodiment where the monomers are completely free of other functional group-containing monomers as well as an embodiment unintentionally including, for instance, approximately up to 0.02 (typically up to 0.01%) other functional group-containing monomers by weight.

Other than the aforementioned functional group-containing monomer, the monomers may include a copolymerizable monomer (comonomer) as a secondary monomer for the purpose of improving the cohesiveness or the like. Examples of such other copolymerizable monomers include vinyl ester monomers such as vinyl acetate, vinyl propionate, and vinyl laurate; aromatic vinyl compounds such as styrene, substituted styrene (α-methylstyrene and the like), and vinyl toluene; cycloalkyl (meth)acrylates such as cyclohexyl (meth)acrylate, cyclopentyl (meth)acrylate, and isobornyl (meth)acrylate; aromatic ring-containing (meth)acrylates such as aryl (meth)acrylates (e.g. phenyl (meth)acrylate), aryloxyalkyl (meth)acrylates (e.g. phenoxyethyl (meth)acrylate), and arylalkyl (meth)acrylates (e.g. benzyl (meth)acrylate); olefinic monomers such as ethylene, propylene, isoprene, butadiene, and isobutylene; chlorine-containing monomers such as vinyl chloride and vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; and vinyl ether monomers such as methyl vinyl ether and ethyl vinyl ether.

For a crosslinking purpose, etc., the monomers may include a polyfunctional monomer as the other copolymerizable monomer. Examples of the polyfunctional monomer include monomers having two or more (e,g, three or more) polymerizable functional groups per molecule such as 1,6-hexanediol di(meth)acrylate, ethylene di(meth)acrylate, propylene glycol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, ethylene oxide-modified trimethylolpropane tri(meth)acrylate, pentaerythritol tri(meth)acrylate, dipentaerythritol penta(meth)acrylate, and dipentaerythritol hexa(meth)acrylate. The polymerizable functional group is typically a (meth)acryloyl group. The polyfunctional monomers can be used solely as one species or in a combination of two or more species.

The amount of such other copolymerizable monomers is not particularly limited and may be suitably selected according to the purpose and application. From the standpoint of suitably obtaining the effect of the use thereof, it is usually 0.01% by weight or greater, possibly 0.05% by weight or greater, or even 0.5% by weight or greater. From the standpoint of facilitating the balance of adhesive properties, the other copolymerizable monomer content in the monomers is usually suitably 20% by weight or less, possibly 10% by weight or less, 5% by weight or less, or even 1% by weight or less. The art disclosed herein can be preferably implemented in an embodiment where the monomers are essentially free of other copolymerizable monomers.

The method for obtaining the acrylic polymer is not particularly limited. Various polymerization methods known as synthetic means for acrylic polymers can be suitably employed, with the methods including a solution polymerization method, emulsion polymerization method, bulk polymerization method, suspension polymerization method, photopolymerization method, etc. For example, a solution polymerization method can be preferably used. The polymerization temperature in the solution polymerization can be suitably selected according to the type of monomer and solvent to be used, the type of polymerization initiator, and the like, and is, for example, about 20° C. to 170° C. (typically, about 40° C. to 140° C.).

In solution polymerization, the solvent (polymerization solvent) used for polymerization can be suitably selected among heretofore known organic solvents. For instance, one species of solvent or a mixture of two or more species of solvent can be used, selected from aromatic compounds (typically aromatic hydrocarbons) such as toluene; acetic acid esters such as ethyl acetate; aliphatic or alicyclic hydrocarbons such as hexane and cyclohexane; halogenated alkanes such as 1,2-dichloroethane; lower alcohols (e.g. monohydric alcohols with one to four carbon atoms) such as isopropanol; ethers such as tert, butyl methyl ether; and ketones such as methyl ethyl ketone.

The initiator used for polymerization can be suitably selected from conventionally known polymerization initiators according to the type of polymerization method. For example, one or two or more species of azo polymerization initiators such as 2,2′-azobisisobutyronitrile (AIBN) can be preferably used. Other examples of the polymerization initiator include persulfates such as potassium persulfate; peroxide initiators such as benzoyl peroxide and hydrogen peroxide; substituted ethane initiators such as phenyl-substituted ethane; and aromatic carbonyl compounds. Still other examples of the polymerization initiator include redox type initiators based on a combination of a peroxide and a reducing agent. Such polymerization initiators can be used singly as one species or in a combination of two or more species. The amount of the polymerization initiator used may be a usual amount used, for example, about 0.005 to 1 part by weight (typically, about 0.01 to 1 part by weight) with respect to 100 parts by weight of the monomers.

The solution polymerization yields a polymerization reaction mixture with acrylic polymer dissolved in an organic solvent. The PSA layer in the art disclosed herein may be formed from a PSA composition comprising the polymerization reaction mixture or an acrylic polymer solution obtained by subjecting the reaction mixture to a suitable work-up. For the acrylic polymer solution, the polymerization reaction mixture can be used after adjusted to suitable viscosity and/or concentration as necessary Alternatively, an acrylic polymer can be synthesized by a polymerization method other than solution polymerization, such as emulsion polymerization, photopolymerization, bulk polymerization, etc., and an acrylic polymer solution prepared by dissolving the acrylic polymer in an organic solvent can be used as well.

### (Base Polymer's Tg)

In the art disclosed herein, the PSA's base polymer (e.g. acrylic polymer) is preferably designed to have a glass transition temperature (Tg) of about −15° C. or lower (e.g. about −70° C. or higher and −15° C. or lower). Here, the polymer's Tg refers to the Tg value determined by the Fox equation based on the composition of the monomers used in synthesizing the polymer. As shown below, the Fox equation is a relational expression of the Tg of a copolymer and the glass transition temperatures Tgi of the homopolymers obtained by homopolymerization of the monomers constituting the copolymer.

1/Tg=Σ(Wi/Tgi)

In the Fox equation above, Tg represents the glass transition temperature (unit: K) of the copolymer, Wi the weight fraction (copolymerization ratio by weight) of a monomer i in the copolymer, and Tgi the glass transition temperature (unit: K) of the homopolymer of the monomer i.

As for the glass transition temperatures of homopolymers used in determining the Tg, values disclosed in publicly known resources are used. For instance, with respect to the monomers listed below, as the glass transition temperatures of their corresponding homopolymers, the following values are used.

| | |
|---|---|
| 2-ethylhexyl acrylate | −70° C. |
| isononyl acrylate | −60° C. |
| n-butyl acrylate | −55° C. |
| ethyl acrylate | −22° C. |
| methyl acrylate | 8° C. |
| methyl methacrylate | 105° C. |
| 2-hydroxyethyl acrylate | −15° C. |
| 4-hydroxybutyl acrylate | −40° C. |
| vinyl acetate | 32° C. |
| acrylic acid | 106° C. |
| methacrylic acid | 228° C. |

With respect to the glass transition temperatures of homopolymers of other monomers besides those exemplified above, the values given in “Polymer Handbook” (3rd edition, John Wiley & Sons, Inc., Year 1989) are used. When the Polymer Handbook provides two or more values for a certain monomer, the highest value is used. In cases where the values are not described in the Polymer Handbook, those that can be obtained by the measuring method described in Japanese patent Application Publication No. 2007-51271 is used.

In some embodiments, the base polymer's Tg is, for instance, possibly −70° C. or higher, or usually preferably −65° C. or higher. With increasing Tg of the base polymer, the resistance to deformation in shear directions tends to increase. In some preferable embodiments, the base polymer's Tg can be −60° C. or higher, or even −55° C. or higher From the standpoint of the tightness of adhesion to adherends (e.g. waterproof membrane laminated with a PSA sheet), the base polymer's Tg is usually advantageously −25° C. or lower, for instance, possibly −35° C. or lower, −40° C. or lower, or even −45° C. or lower.

The weight average molecular weight (Mw) of the base polymer (preferably acrylic polymer) in the art disclosed herein is not particularly limited, and may be, for example, in the range of about 10×10⁴ to 500×10⁴. From the standpoint of PSA performance, the Mw of the base polymer is in the range of about 30×10⁴ to 200×10⁴ (more preferably, about 45×10⁴ to 150×10⁴, typically about 65×10⁴ to 130×10⁴). Here, Mw refers to a standard polystyrene equivalent value obtained by gel permeation chromatography (GPC). As the GPC apparatus, for example, model name “HLC-8320 GPC” (column: TSK gel GMH-H (S), available from Tosoh Corporation) can be used.

### (Crosslinking Agent)

The PSA layer in the art disclosed herein can be formed of crosslinked PSA. Crosslinking of PSA can be a useful means of adjusting the PSA layer's storage moduli G′ to within the favorable ranges disclosed herein.

The type of crosslinking agent is not particularly limited. For instance, a suitable species can be selected and used among epoxy-based crosslinking agents, isocyanate-based crosslinking agents, oxazoline-based crosslinking agents, aziridine-based crosslinking agents, melamine-based crosslinking agents, carbodiimide-based crosslinking agents, hydrazine-based crosslinking agents, metal chelate-based crosslinking agents, silane coupling agents, peroxide-based crosslinking agents, urea-based crosslinking agents, metal alkoxide-based crosslinking agents, metal salt-based crosslinking agents, and amine-based crosslinking agents. For the crosslinking agent, solely one species or a combination of two or more species can be used. Particularly preferable crosslinking agents include epoxy-based crosslinking agents and isocyanate-based crosslinking agents. These can be used separately; or epoxy-based and isocyanate-based crosslinking agents can be used together as described later.

As the epoxy-based crosslinking agent, a compound having two or more epoxy groups per molecule can be used without particular limitations. An epoxy-based crosslinking agent having 3 to 5 epoxy groups per molecule is preferable. Epoxy-based crosslinking agents can be used singly as one species or in a combination of two or more species. Specific examples of the epoxy-based crosslinking agent include, but are not limited to, N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether. Examples of commercially available epoxy-based crosslinking agents include product names TETRAD-C and TETRAD-X both available from Mitsubishi Gas Chemical Co., Inc., product name EPICLON CR-5L available from DIC Corp., product name DENACOL EX-512 available from Nagase ChemteX Corporation, and product name TEPIC-G available from Nissan Chemical Industries, Ltd.

As the isocyanate-based crosslinking agent, a poly functional isocyanate (which refers to a compound having an average of two or more isocyanate groups per molecule, inclusive of compounds having an isocyanurate structure) can be preferably used. For the isocyanate-based crosslinking agent, solely one species or a combination of two or more species can be used. A preferable polyfunctional isocyanate has an average of three or more isocyanate groups per molecule. Such a tri-functional or higher polyfunctional isocyanate can be a multimer (typically a dimer or a trimer), a derivative (e.g., an adduct of a polyol and two or more polyfunctional isocyanate molecules), a polymer or the like of a di-functional, tri-functional, or higher polyfunctional isocyanate. Examples include poly-functional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, poly methylene polyphenyl isocyanate, polyether polyisocyanate, and polyester polyisocyanate. Commercially available polyfunctional isocyanates include product name DURANATE TPA-100 available from Asahi Kasei Chemicals Corporation and product names CORONATE L, CORONATE HL, CORONATE HK, CORONATE HX, CORONATE 2096 available from Tosoh Corporation, and product name TAKENATE L available from Mitsui Chemicals, Inc.

As the oxazoline-based crosslinking agent, a species having at least one oxazoline group per molecule can be used without particular limitations. The oxazoline group can be a 2-oxazoline group, 3-oxazoline group, or 4-oxazoline group. It is usually preferable to use an oxazoline-based crosslinking agent having a 2-oxazoline group.

Examples of aziridine-based crosslinking agents include trimethylolpropane tris[3-(1-aziridinyl)propionate] and trimethylolpropane tris[3-(1-(2-methyl)aziridinylpropionate)].

Examples of melamine-based crosslinking agents include hexamethylol melamine and butylated melamine resin.

Examples of carbodiimide-based crosslinking agents include CARBODILITE series (available from Nisshinbo Industries, Inc.) such as CARBODILITE V series including CARBODILITE V-02, CARBODILITE V-02-L2 and CARBODILITE V-04; and the CARBODILITE E series including CARBODILITE E-01, CARBODILITE E-02, and CARBODILITE E-04.

The hydrazine-based cross-linking agent is a hydrazino group-containing compound having a hydrazino group (H₂N—NH—) as a crosslinkable functional group. Specific examples include polyhydrazide polycarboxylic acids such as dihydrazide oxalic acid, dihydrazide malonic acid, dihydrazide glutaric acid, dihydrazide succinic acid, and dihydrazide adipic acid; and hydantoins such as 1,3-bis(hydrazinocarbonoethyl)-5-isopropylhydantoin.

Examples of metal chelate-based crosslinking agents include aluminum chelate-based compounds, titanium chelate-based compounds, zinc chelate-based compounds, zirconium chelate-based compounds, iron chelate-based compounds, cobalt chelate-based compounds, nickel chelate-based compounds, tin chelate-based compounds, manganese chelate-based compounds, and chromium chelate-based compounds.

As the silane coupling agent, it is possible to use a heretofore known species having, as a crosslinkable functional group, a silicon (Si)-containing group (typically, an alkoxysilyl group). Non-limiting examples of silane coupling agents include 3-glycidoxypropyltrimethoxysilane, 3-glycidoxypropyltriethoxysilane, 3-glycidoxypropylmethyldiethoxysilane, and 3-aminopropyltrimethoxysilane.

When using an epoxy-based crosslinking agent, its amount used is not particularly limited. For instance, it can be more than 0 part by weight and 1 part by weight or less to 100 parts by weight of the base polymer. The amount of epoxy-based crosslinking agent used to 100 parts by weight of base polymer can be, for instance, 0.001 part by weight or greater, 0.002 part by weight or greater, 0.005 part by weight or greater, or even 0.007 part by weight or greater. With increasing use of crosslinking agent, the PSA's storage modulus G′ tends to increase. From the standpoint of increasing the tightness of adhesion to adherends (e.g. waterproof membrane), the amount of epoxy-based crosslinking agent used to 100 parts by weight of base polymer is usually suitably 0.5 part by weight or less, possibly 0.3 part by weight or less, or even less than 0.2 part by weight. In some embodiments, the amount of epoxy-based crosslinking agent used to 100 parts by weight of base polymer can be less than 0.1 part by weight, or even less than 0.08 part by weight.

When using an isocyanate-based crosslinking agent, the amount used is not particularly limited. For instance, it can be more than 0 part by weight and 10 parts by weight or less to 100 parts by weight of base polymer. The amount of isocyanate-based crosslinking agent used to 100 parts by weight of base polymer can be, for instance, 0.1 part by weight or greater, 0.5 part by weight or greater, 0.7 part by weight or greater, or even 0.9 part by weight or greater. With increasing use of crosslinking agent, the PSA's storage modulus G′ tends to increase. From the standpoint of enhancing the tightness of adhesion to the adherend (e.g. waterproof membrane), the amount of the isocyanate-based crosslinking agent used is usually suitably 10 parts by weight or less, possibly 8 parts by weight or less, 5 parts by weight or less, or even 3 parts by weight or less to 100 parts by weight of the base polymer. In some embodiments, the amount of isocyanate-based crosslinking agent used to 100 parts by weight of the base polymer may be less than 3 parts by weight, 2.5 parts by weight or less, or even 2.1 parts by weight or less. The art disclosed herein can also be favorably practiced in an embodiment where the amount of isocyanate-based crosslinking agent used to 100 parts by weight of base polymer is 1.8 parts by weight or less, 1.5 parts by weight or less, or even 1.2 parts by weight or less.

In some embodiments of the art disclosed herein, the membrane-bonding PSA is preferably crosslinked with at least an epoxy-based crosslinking agent. The use of epoxy-based crosslinking agent can favorably inhibit wrinkling of waterproof membrane with aging. In some preferable embodiments, an epoxy-based crosslinking agent and a non-epoxy-based crosslinking agent can be used together. This can favorably balance the PSA's storage modulus G′ and adhesion to adherends and effectively inhibit wrinkling of waterproof membrane with aging. The non-epoxy crosslinking agent can be arbitrarily selected from non-epoxy-based crosslinking agents among the aforementioned examples of crosslinking agent. For instance, an isocyanate-based crosslinking agent can be preferably used as the non-epoxy-based crosslinking agent.

When using an epoxy-based crosslinking agent and a non-epoxy-based crosslinking agent (e.g. isocyanate-based crosslinking agent) together, no particular limitations are imposed on the their relative amounts used. In some embodiments, the amount (by weight) of epoxy-based crosslinking agent used can be, for instance, at least one time the amount of non-epoxy-based crosslinking agent used, at least 5 times, at least 10 times, at least 50 times, at least 100 times, or even at least 1.50 times. The amount (by weight) of epoxy-based crosslinking agent used can be, for instance, up to 500 times the amount of non-epoxy-based crosslinking agent used, up to 250 times, up to 200 times, up to 130 times, or even up to 80 times.

### (Tackifier)

The PSA can include a tackifier. This can increase the adhesion to adherends (e.g. waterproof membrane). The tackifier can be used to adjust the PSA's storage modulus G′ to fall in a favorable range and increase the resistance to deformation in shear directions. Suitable use of tackifier can bring about these effects in a synergistic manner to effectively enhance the ability to reduce the relative displacement of the PSA sheet and adherend. As the tackifier, tackifier resin, acrylic oligomer and the like can be used. For the tackifier, solely one species or a combination of two or more species can be used. The amount of tackifier used to 100 parts by weight of base polymer can be, for instance, 1 part by weight or greater and 150 parts by weight or less, 1 part by weight or greater and 50 parts by weight or less, or even 5 parts by weight or greater and less than 40 parts by weight.

As the tackifier resin, one, two or more species can be selected and used among various known tackifier resins such as phenolic tackifier resins, terpene-based tackifier resins, modified terpene-based tackifier resins, rosin-based tackifier resins, and hydrocarbon-based tackifier resins.

Examples of phenolic tackifier resins include terpene phenolic resins, hydrogenated terpene phenolic resins, alkylphenolic resins, and rosin phenolic resins.

The term “terpene phenolic resin” refers to a resin including a terpene residue and a phenol residue, and is inclusive of both a copolymer of a terpene and a phenol compound (terpene-phenol copolymer resin) and a phenol-modified homopolymer or copolymer of a terpene (phenol-modified terpene resin). Preferred examples of terpenes constituting such terpene phenolic resins include monoterpenes such as α-pinene, μ-pinene, and limonene (including d-form, l-form and d/l form (dipentene)). The hydrogenated terpene phenolic resin has a structure obtained by hydrogenating such a terpene phenolic resin. Such a resin is sometimes referred to as a hydrogen-added terpene phenolic resin.

The alkylphenolic resin is a resin (oily phenolic resin) obtainable from an alkylphenol and formaldehyde. Examples of alkylphenol resins include novolac type and resole type resins.

A rosin phenolic resin is typically a phenol-modified product of rosins or various rosin derivatives (including rosin esters, unsaturated fatty acid-modified rosins, and unsaturated fatty acid-modified rosin esters) described later. Examples of the rosin phenolic resin include rosin phenolic resins obtained, for example, by a method of adding a phenol to a rosin or the rosin derivative with an acid catalyst and thermally polymerizing.

Examples of terpene-based tackifier resins include polymers of terpenes (typically monoterpenes) such as α-pinene, β-pinene, d-limonene, l-limonene, and dipentene. The polymer may be a homopolymer of one type of terpene or a copolymer of two or more types of terpenes. The homopolymers of one type of terpene can be exemplified by an α-pinene polymer, β-pinene polymer, and a dipentene polymer. The modified terpene-based tackifier resin is exemplified by modifications of the terpene resin. Specific examples include styrene-modified terpene resins and hydrogenated terpene resins.

The term “rosin-based tackifier resin” here encompasses both rosins and rosin derivative resins. Examples of rosins include unmodified rosins (raw rosins) such as gum rosin, wood rosin, and tall oil rosin, and modified rosins obtained by modification of the unmodified rosins by hydrogenation, disproportionation, polymerization, and the like (hydrogenated rosins, disproportionated rosins, polymerized rosins, and other chemically modified rosins, etc.).

The rosin derivative resin is typically a derivative of a rosin as those described above. The term “rosin derivative resin” as used herein is inclusive of derivatives of unmodified rosins and derivatives of modified rosins (including hydrogenated rosins, disproportionated rosins and polymerized rosins). Examples thereof include rosin esters such as unmodified rosin esters which are esters of unmodified mains and alcohols, and modified rosin esters which are esters of modified rosins and alcohols; unsaturated fatty acid-modified rosins obtained by modification of rosins with unsaturated fatty acids; unsaturated fatty acid-modified rosin esters obtained by modification of rosin esters with unsaturated fatty acids; rosin alcohols obtained by reduction treatment of carboxy groups of rosins or various abovementioned rosin derivatives (including rosin esters, unsaturated fatty acid-modified rosins and unsaturated fatty acid-modified rosin esters); and metal salts of rosins or various abovementioned rosin derivatives. Specific examples of rosin esters include methyl esters, triethylene glycol esters, glycerin esters, and pentaerythritol esters of unmodified rosins or modified rosins (hydrogenated rosins, disproportionated rosins, polymerized rosins, etc.).

Examples of hydrocarbon-based tackifier resins include various hydrocarbon resins such as aliphatic hydrocarbon resins, aromatic hydrocarbon resins, aliphatic cyclic hydrocarbon resins, aliphatic/aromatic petroleum resins (styrene-olefin copolymers, etc.), aliphatic/alicyclic petroleum resins, hydrogenated hydrocarbon resin, coumarone resins, and coumarone indene resins.

The softening point of the tackifier resin is not particularly limited. From the standpoint of increasing the storage modulus G′, it is usually preferable to use a tackifier resin having a softening point (softening temperature) of 90° C. or higher, more preferably 115° C. or higher, for instance, 130° C. or higher. It is also possible to use a tackifier resin (e.g. terpene phenol resin) having a softening point of 135° C. or higher, or 140° C. or higher The art disclosed herein can be preferably implemented in an embodiment where the tackifier resin having an aforementioned softening point accounts for more than 50% (preferably more than 70%, more preferably more than 90%) by weight of the total amount of the tackifier resins used. The upper limit of the softening point of the tackifier resin is not particularly limited. From the standpoint of improving the adhesion to an adherend, in one embodiment, a tackifier resin having a softening point of 200° C. or lower (more preferably 180° C. or lower) can be preferably used. The softening point of the tackifier resin can be measured based on a softening point test method (ring and ball method) prescribed in JIS K 2207.

The amount of tackifier resin used is not particularly limited. For instance, it can be suitably selected in the range of 1 part by weight or greater and 150 parts by weight or less to 100 parts by weight of base polymer (e.g. acrylic polymer). From the standpoint of favorably obtaining the effect to increase the adhesiveness to adherends, the amount of tackifier resin used to 100 parts by weight of base polymer is usually suitably 5 parts by weight or greater, possibly 10 parts by weight or greater, 15 parts by weight or greater, 20 parts by weight or greater, or even 25 parts by weight or greater. With increasing use of tackifier resin, the storage modulus G′ tends to increase. From the standpoint of the tightness of adhesion to adherends and heat-resistant cohesive strength, the amount of tackifier resin used to 100 parts by weight of base polymer is usually suitably 80 parts by weight or less, possibly 50 parts by weight or less, less than 40 parts by weight, or even less than 35 parts by weight.

As the tackifier, an acrylic oligomer can also be used. As the acrylic oligomer, it is possible to use a polymer of monomers that comprise more than 50% acrylic monomer by weight, the polymer typically having a Tg of 0° C. or higher. From the standpoint of the miscibility, the use of acrylic oligomer as a tackifier is particularly preferable in an acrylic PSA.

The acrylic oligorner's Tg is usually suitably in the range of 0° C. or higher and 300° C. or lower. With the acrylic oligomer having a Tg in this range, wrinkling of waterproof membrane tends to be favorably inhibited. From the standpoint of increasing the storage modulus G′, in some embodiments, the acrylic oligomer's Tg can be, for instance, 25° C. or higher, 40° C. or higher, 50° C. or higher, or even 60° C. or higher. From the standpoint of the tightness of adhesion to adherends, in some embodiments, the acrylic oligomer's Tg can be, for instance, 200° C. or lower, 150° C. or lower, 120° C. or lower, 100° C. or lower, or even 80° C. or lower. Just like the base polymer's Tg, the acrylic oligomer's Tg is a value determined based on the Fox equation.

The acrylic oligomer may have a weight average molecular weight (Mw) of, for instance, 1,000 or higher and below 30,000. When the Mw is within this range, it is possible to inhibit lowering of cohesive strength while effectively enhancing the adhesion to adherends. In some preferable embodiments, the acrylic oligomer's Mw can be, for instance, 1500 or higher, 2000 or higher, 2500 or higher, or even 3000 or higher. From the standpoint of the miscibility and the tightness of adhesion to adherends, in some embodiments, the acrylic oligomer's Mw can be, for instance, lower than 20000, lower than 10000, 7000 or lower, 5000 or lower, 4500 or lower, or even 4000 or lower. The acrylic oligorner's Mw can be determined by gel permeation chromatography (GPC) as a value based on standard polystyrene.

Examples of the monomers forming the acrylic oligomer include (meth)acrylates ((meth)acrylic acid esters) including alkyl (meth)acrylate such as methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, tert-butyl (meth)acrylate, pentyl (meth)acrylate, isopentyl (meth)acrylate, hexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, and dodecyl (meth)acrylate; an ester of (meth)acrylic acid and an alicyclic alcohol (alicyclic hydrocarbon group-containing (meth)acrylate), such as cyclohexyl (meth)acrylate, isobornyl (meth)acrylate, and dicyclopentanyl (meth)acrylate; aryl (meth)acrylate such as phenyl (meth)acrylate and benzyl (meth)acrylate; and a (meth)acrylate derived from a terpene compound derivative alcohol. These (meth)acrylates may be used solely as one species or in combination of two or more species.

From the standpoint of enhancing the resistance to deformation in shear directions, the acrylic oligomer preferably comprises, as a monomeric unit, an acrylic monomer having a relatively bulky structure, typified by an alkyl (meth)acrylate having a branched alkyl group, such as isobutyl (meth)acrylate, tert-butyl (meth)acrylate, etc.; an ester of a (meth)acrylic acid and an alicyclic alcohol (alicyclic hydrocarbon group-containing (meth)acrylate), such as cyclohexyl (meth)acrylate, isobornyl (meth)acrylate, dicyclopentanyl (meth)acrylate, etc.; or an aryl (meth)acrylate such as phenyl (meth)acrylate, benzyl (meth)acrylate, etc. When UV light is used in synthesizing the acrylic oligomer or forming the PSA layer, a saturated oligomer is preferable because it is less likely to inhibit polymerization. An alkyl (methacrylate having a branched alkyl group or an ester of an alicyclic alcohol (alicyclic hydrocarbon group-containing (meth)acrylate) can be favorably used as a monomer constituting the acrylic oligomer. The branched acyclic alkyl (meth)acrylate, alicyclic hydrocarbon group-containing (meth)acrylate and aryl (meth)acrylate are all included in the (meth)acrylate monomer in the art disclosed herein. The alicyclic hydrocarbon group can be a saturated or unsaturated alicyclic hydrocarbon group.

The ratio of the (meth)acrylate monomer (e.g. an alicyclic hydrocarbon group-containing (meth)acrylate) in the entire monomers forming the acrylic oligomer is typically higher than 50% by weight, preferably 60 % by weight or higher, more preferably 70% by weight or higher, possibly 80% by weight or higher, or even 90% by weight or higher. The acrylic oligomer may have a monomer composition essentially consisting of a (meth)acrylate monomer.

As the monomers forming the (meth)acrylic oligomer, a functional group-containing monomer can be used in addition to the acrylate monomer. A functional group-containing monomer may help increase at least one among the compatibility with the base polymer, PSA's cohesion, adhesion to adherends, etc. Favorable examples of the functional group-containing monomer include a monomer having a nitrogen-containing ring (typically, a nitrogen-containing heterocycle) such as N-vinyl-2-pyrrolidone and N-acryloylmorpholine; an amino group-containing monomer such as N,N-dimethylaminoethyl (methacrylate; an amide group-containing monomer such as N,N-diethyl(meth)acrylamide; a carboxyl group-containing monomer such as AA and MAA; and a hydroxy group-containing monomer such as 2-hydroxyethyl (meth)acrylate. Of these functional group-containing monomers, solely one species or a combination of two or more species can be used. Among them, the carboxyl group-containing monomer is preferable and AA is particularly preferable.

When the monomers forming the acrylic oligomer includes a functional group-containing monomer, the ratio of the functional group-containing monomer (e.g. a carboxyl group-containing monomer such as AA) in the entire monomers can be, for instance, 0.5% by weight or higher, 1% by weight or higher, 2% by weight or higher, or even 3% by weight or higher. The ratio of the functional group-containing monomer is typically below 50% by weight. From the standpoint of the tightness of adhesion to adherends, it is usually suitably 40% by weight or lower, possibly 25% by weight or lower, 15% by weight or lower, 10% by weight or lower, or even 7% by weight or lower.

The (meth)acrylic oligomer can be formed by polymerizing its monomer components. The method or embodiment of polymerization is not particularly limited. Various heretofore known polymerization methods (e.g. solution polymerization, emulsion polymerization, bulk polymerization, photopolymerization, radiation polymerization, etc.) can be employed in suitable embodiments. The species of polymerization initiator (e.g. an azo-based polymerization initiator such as AIBN) that can be used as necessary is generally as exemplified in the synthesis of acrylic polymer. The amounts of polymerization initiator and optionally-used chain transfer agent such as n-dodecyl mercaptan can be suitably selected based on common technical knowledge so as to obtain a desirable molecular weight. Details are thus omitted here.

From the same standpoint, preferable examples of the acrylic oligomer include the respective homopolymers of dicyclopentanyl methacrylate (DCPMA), cyclohexylmethacrylate (CHMA), isobornyl methacrylate (IBXMA), isobornyl acrylate (IBXA), dicyclopentanyl acrylate (DCPA), 1-adamanthyl methacrylate (ADMA), and 1-adamanthyl acrylate (ADA); as well as a copolymer of CHMA and isobutyl methacrylate (IBMA), copolymer of CHMA and IBXMA, copolymer of CHMA and acryloyl morpholine (ACMO), copolymer of CHMA and diethylacrylamide (DEAA), copolymer of CHMA and AA, copolymer of ADA and methyl methacrylate (MMA), copolymer of DCPMA and IBXMA, copolymer of DCPMA and MMA, copolymer of AA and an aforementioned (meth)acrylate, and copolymer of AA and a monomer forming an aforementioned copolymer.

When using an acrylic oligomer, its amount used can be, for instance, 1 part by weight or greater to 100 parts by weight of the base polymer (e.g. acrylic polymer). From the standpoint of obtaining greater effect of the acrylic oligomer, the amount of the acrylic oligomer used can be, for instance, 5 parts by weight or greater, 8 parts by weight or greater, 10 parts by weight or greater, 15 parts by weight or greater, or even 20 parts by weight or greater. From the standpoint of the compatibility with the base polymer, etc., the acrylic oligomer content is usually suitably 50 parts by weight or less, possibly 45 parts by weight or less, less than 40 parts by weight, 35 parts by weight or less, or even less than 30 parts by weight.

### (Other Additives)

Besides the respective components described above, the PSA composition may include, as necessary, various additives which are common in the field of PSA, such as leveling agent, crosslinking aid, plasticizer, softener, antistatic agent, antiaging agent, ultraviolet absorber, antioxidant, and photostabilizer. As for these various additives, heretofore known additives can be used by conventional methods, and the present invention is not particularly characterized thereby. Therefore, detailed description thereof will be omitted.

(PSA layer)

The PSA layer in the waterproof cover disclosed herein can be formed from a water-based PSA composition, solvent-based PSA composition, hot-melt PSA composition, or active energy ray-curable PSA composition which cures when irradiated with active energy rays such as UV rays and electron rays. The water-based PSA composition refers to a PSA composition that comprises a PSA (PSA layer-forming components) in a solvent formed of water as the main component (water based solvent), encompassing a water-dispersed PSA composition (a composition comprising PSA at least partially dispersed in water) and an aqueous solution-type PSA composition (a composition comprising PSA dissolved in water). Further, the solvent-based PSA composition means a PSA composition that comprises a PSA in an organic solvent. From the standpoint of adhesive properties and the like, the art disclosed herein can be preferably implemented in an embodiment in which the PSA layer is formed from a solvent-based PSA composition.

The PSA layer can be formed by a conventionally known method. For example, a method for forming a PSA layer by applying a PSA composition to a releasable surface (release surface) and drying can be used. With a PSA sheet configured to have a support substrate, for example, a direct method for forming a PSA layer by directly applying (typically, coating) a PSA composition to the support substrate followed by drying can be used. A transfer method may also be used in which a PSA composition is applied to a releasable surface (release surface) and dried to form a PSA layer, and the PSA layer is then transferred to a support substrate. For example, the surface of a release liner described hereinbelow can be preferably used as the release surface. The PSA layer in the art disclosed herein is typically formed in a continuous form, but not limited to such forms and may be formed, for instance, in a random or regular pattern of dots, stripes, etc.

The PSA layer's thickness is not particularly limited. For instance, it can be suitably selected in the range of 1 μm or greater and 150 μm or less. From the standpoint of avoiding making the PSA sheet excessively thick, the PSA layer can have a thickness of, for instance, 100 μm or less, 70 μm or less, or even 50 μm or less. From the standpoint of thinning the waterproof cover and ease of processing, in some embodiments, the PSA layer's thickness can be, for instance, 40 μm or less, 35 μm or less, 30 μm or less, less than 25 μm, 22 μm or less, or even 17 μm or less. From the standpoint of the tightness of adhesion to adherends, the PSA layer's thickness is usually advantageously 3 μm or greater, possibly 5 μm or greater, 8 μm or greater, 10 μm or greater, or even 15 μm or greater. In some embodiments, the PSA layer's thickness can be 20 μm or greater, 25 μm or greater, 30 μm or greater, or even 40 μm or greater.

While no particular limitations are imposed, the PSA layer may have a gel fraction of, for instance, 10% or higher. Here, the PSA layer's gel fraction is determined by the following method: In particular, a measurement sample having a weight W1 is wrapped in a porous PTFE sheet and suspended in ethyl acetate at room temperature for one week. Subsequently, the measurement sample is allowed to dry. The ethyl acetate-insoluble portion is measured for weight W2. W1 and W2 are substituted into the next equation to determine the gel fraction:

Gel fraction (%)=W2/W1×100

As the porous PTFE sheet, trade name NITOFLON® NTF 1122 available from Nitto Denko Corporation or an equivalent product can be used. The same measurement method is used in the working examples described later.

From the standpoint of increasing the resistance to deformation in shear directions, the gel fraction is usually advantageously 20% or higher, possibly 30% or higher, 35% or higher, 40% or higher, or even 45% or higher. In some embodiments, the gel fraction is 55% or higher, 65% or higher, or even 75% or higher. The maximum gel fraction is theoretically 100%. From the standpoint of the tightness of adhesion to adherends, the PSA layer has a gel fraction of usually suitably 95% or lower, possibly 90% or lower, 85% or lower, 80% lower, or even 70% or lower. The PSA layer's gel fraction can be adjusted through, for instance, the base polymer's composition and molecular weight, use of crosslinking agent and tackifier as well as selections of their types and amounts used if any, etc.

### (Substrate)

In the art disclosed herein, the PSA sheet laminated on the periphery of waterproof membrane can be a substrate-free PSA sheet formed of a PSA layer, or a substrate-supported PSA sheet having a PSA layer on at least the first face (waterproof membrane-side surface) of the substrate. The substrate-supported. PSA sheet can be an adhesively double-faced substrate-supported PSA sheet having first and second PSA layers on the first face and the second face (outer surface) of the substrate, or an adhesively single-faced substrate-supported PSA sheet having a PSA layer only on the first face of the substrate.

In an embodiment of the PSA sheet as an adhesively single-faced or double-faced, substrate-supported PSA sheet, as the substrate, it is possible to use a resin film, paper, cloth, a rubber sheet, a foam sheet, a metal foil, and composites thereof. Examples of resin film include polyester film; polyolefin film; vinyl chloride resin film; vinyl acetate resin film; polyimide resin film; polyamide resin film; polyurethane film; and cellophane. Examples of paper include Japanese paper, craft paper, glassine paper, high-quality paper, synthetic paper, and top coat paper. Examples of the cloth include a woven fabric and a nonwoven fabric made of various fibrous substances which are used singly or mixed with each other. Examples of the fibrous substance include cotton, staple fiber, manila hemp, pulp, rayon, acetate fiber, polyester fiber, polyvinyl alcohol fiber, polyamide fiber, and polyolefin fiber. Examples of the rubber sheet include a natural rubber sheet and a butyl rubber sheet. Examples of the foam sheet include a foamed polyolefin sheet, foamed polyurethane sheet and foamed polychloroprene rubber sheet. Examples of the metal foil include an aluminum foil and a copper foil.

The term “nonwoven fabric” as used herein refers to a nonwoven fabric for PSA sheets, which is mainly used in the field of PSA tapes and other PSA sheets, and is typically a nonwoven fabric such as prepared using a general paper machine (sometimes referred to as so-called “paper”). The resin film referred to herein is typically a nonporous resin sheet which is distinguished from, for example, a nonwoven fabric (that is, not inclusive of a nonwoven fabric). The resin film may be any of a non-stretched film, a uniaxisily stretched film, and a biaxially stretched film.

Favorable examples of the substrate include resin film and a foam sheet. From the standpoint of the ease of processing and inhibition of deformation of the PSA sheet in shear direction, in some embodiments, resin film can be preferably used. Favorable examples of resin film include polyester film, polyolefin film and polyimide (PI) film. Specific examples of polyester film include polyethylene terephthalate (PET) film, polybutylene terephthalate film, polyethylene naphthalate film and polybutylene naphthalate film. Specific examples of polyolefin film include polypropylene (PP) film such as non-stretched polypropylene (CPP) film and biaxially-stretched polypropylene (OPP) film; polyethylene (PE) film such as low-density polyethylene (LDPE) film, linear low-density polyethylene (LLDPE) film, medium-density polyethylene (MDPE) film, high-density polyethylene (HDPE) film, and blend film of two or more species of polyethylene; and PP/PE blend film in which polypropylene and polyethylene are blended. From the standpoint of the strength and size stability, particularly preferable substrates include PET film and PI film.

The thickness of the substrate is not particularly limited. From the standpoint of thinning the waterproof cover, the substrate's thickness is usually suitably 200 μm or less, 100 μm or less, 80 μm or less, or even 50 μm or less. In some embodiments, the substrate's thickness can be, for instance, 30 μm or less, 20 μm or less, or even 10 μm or less. From the standpoint of the PSA sheet's handling properties and processability, etc., the substrate's thickness is usually suitably about 2 μm or greater, possibly 3 μm or greater, or even 7 μm or greater. In some embodiments, the substrate's thickness can be, for instance, greater than 10 μm, greater than 15 μm, or even greater than 25 μm.

The substrate's surface can be subjected to a heretofore known surface treatment such as corona discharge treatment, plasma treatment, ultraviolet irradiation treatment, acid treatment, alkali treatment, and primer coating. Such a surface treatment can be a treatment for improving the adhesiveness between the substrate and the PSA layer, in other words, for improving the anchoring property of the PSA layer to the support substrate.

### (Properties of PSA Sheet, etc.)

In the 40° C. holding power test carried out by the method described later in Examples, the PSA sheet disclosed herein preferably exhibits a level of cohesive strength to show a displacement (displaced distance) of 0.5 mm or less after one hour (i.e. a displacement of 0.5 mm/h or less). In some embodiments, the displacement is preferably 0.4 mm or less, more preferably 0.3 mm or less, yet more preferably 0.2 μm or less, possibly less than 0.2 mm, or even 0.15 mm or less. According to the waterproof cover constituted using a PSA sheet that has a smaller displacement in the 40° C. holding power test, the wrinkling of the waterproof membrane tends to be better inhibited. The lower limit of the displacement is 0.0 mm.

In the 80° C. holding power test carried out by the method described later in Examples, the PSA sheet disclosed herein preferably shows a level of cohesive strength to show a displacement (displaced distance) of 1.0 mm or less after one hour (i.e. a displacement of 1.0 mm/h or less). In some embodiments, the displacement is preferably 0.6 mm or less, more preferably 0.5 mm or less, yet more preferably 0.4 mm or less, possibly 0.3 mm or less, or even less than 0.3 mm. According to a waterproof cover constituted using a PSA sheet that has a smaller displacement in the 80° C. holding power test, the wrinkling of the waterproof membrane tends to be better inhibited. The lower limit of the displacement is 0.0 mm.

With respect to the adhesive face on the waterproof membrane-bonding side, the PSA sheet disclosed herein preferably has a to-PTFE peel strength (peel strength to porous PTFE film) of 2.0 N/20 mm or greater. The PSA sheet showing such peel strength readily suppress the displacement of waterproof membrane and is suited for preventing wrinkling of the waterproof membrane. The to-PTFE peel strength is determined by the method described later in Examples. In some embodiments, the peel strength can be, for instance, 3.0 N/20 mm or greater, or even 4.0 N/20 mm or greater. The maximum to-PTFE peel strength is not particularly limited. From the standpoint of simultaneously obtaining a preferable storage modulus G′ disclosed herein, in some embodiments, the peel strength can be, for instance, 15 N/20 mm or less, 10 N/20 mm or less, 8.0 N/20 mm or less, or even 6.0 N/20 mm or less.

The to-PTFE peel strength can be determined as follows: In particular, as the adherend, a stainless steel plate is used, having a surface to which a porous PTFE film is fixed with double-faced PSA tape. As the porous PTFE film, porous PTFE film prepared by the method described later in Examples or a comparable product is used. The PSA sheet is cut to a 20 mm wide, 100 mm long size to prepare a measurement sample. In an environment at 23° C. and 50% RH, the adhesive face of the measurement sample is press-bonded to the adherend surface (porous PTFE film's surface) with a 2 kg roller moved back and forth once. This is left in the same environment for 30 minutes. Subsequently, using a universal tensile compression tester, based on JIS Z 0237:2009, the peel strength (N/20 mm) is determined at a tensile speed of 300 mm/min at a peel angle of 180°. As the universal tensile compression tester, for example, “TENSILE COMPRESSION TESTER, TG-1 kN” available from Minebea Co., Ltd. can be used. As necessary, a suitable resin film can be adhered for backing to the reverse face of the adhesive face subject to measurement, and the backed PSA sheet can be cut to the size to prepare a measurement sample for use. As the backing film, for instance, a PET film of about 25 μm in thickness can be used.

In the art disclosed herein, the thickness of the PSA sheet is not particularly limited. For instance, it can be in the range between about 5 μm and 300 μm. From the standpoint of reducing the waterproof cover's thickness, the PSA sheet's thickness is usually suitably 200 μm or less, possibly 150 μm or less, 100 μm or less, 70 μm or less, or even 40 μm or less. From the standpoint of the processability and handling properties, in some embodiments, the PSA sheet's thickness can be, for instance, 10μm or greater, 15 μm or greater, 20 μm or greater, or even 25 μm or greater. In the substrate-free PSA sheet, the PSA layer's thickness is the PSA sheet's thickness.

### <Waterproof Cover>

The waterproof cover disclosed herein can be prepared by layering the PSA sheet on the periphery of at least one face of a waterproof membrane and bonding the PSA sheet via its PSA layer to the waterproof membrane. No particular limitations are imposed on the method for preparing the waterproof cover from a waterproof membrane and a PSA sheet. For instance, in a continuous PSA sheet, a hole is formed by punching or like means, with the hole corresponding to the area effective as a waterproofed region in the waterproof cover to be produced; and the PSA sheet having the hole is laminated on the waterproof membrane. The laminate is further punched, etc., to obtain a waterproof cover in a desirable shape.

When the PSA sheet laminated peripherally to the waterproof membrane is a substrate-free PSA sheet formed of a PSA layer, this PSA layer is the membrane-bonding PSA layer (the PSA layer bonded to the waterproof membrane). In a substrate-supported single-faced PSA sheet having a PSA layer only on one (first) face of a substrate, this PSA layer is the membrane-bonding PSA layer. In a substrate-supported double-faced PSA sheet having first and second PSA layers on first and second faces of a substrate, the first PSA layer is the membrane-bonding PSA layer. When using a substrate-supported double-faced PSA sheet, the PSA (first PSA) forming the first PSA layer can be the same as or different from the PSA (second PSA) forming the second PSA layer. For instance, from the standpoint of enhancing the adhesion of the waterproof cover to adherends (e.g. a container having an opening), the second PSA may have a lower 40° C. storage modulus G′ than that of the first PSA. In particular, the second PSA's 40° C. storage modulus G′ can be, for instance, below 53000 Pa, below 50000 Pa, or even below 40000 Pa. The base polymer of the second PSA may have a lower Tg than that of the first PSA. When the first PSA includes a tackifier, the second PSA may include the same or a different tackifier as or from the first PSA in an amount greater than or less than the first PSA relative to 100 parts by weight of base polymer of each PSA, or may be free of a tackifies. When a crosslinking agent is used in the first PSA, in the second PSA, the same or a different crosslinking agent as or from the first PSA may be used in an amount greater than or less than the first PSA relative to 100 parts by weight of base polymer of each PSA, or no crosslinking agent may be used. The second PSA layer's thickness can be similar to or different from the first PSA layer's thickness.

In addition to the PSA sheet (first PSA sheet) laminated peripherally on one face of the waterproof membrane, when the waterproof cover disclosed herein has another PSA sheet (second PSA sheet) laminated peripherally on the other face of the waterproof membrane, the second PSA sheet's constitution can be the same as or different from the first PSA sheet's constitution. For instance, the waterproof cover disclosed herein can be in an embodiment having the first and second PSA sheets between which one is a substrate-supported (single-faced or double-faced) PSA sheet and the other is a substrate-free PSA sheet. The waterproof cover in such an embodiment can be advantageous in terms of thickness reduction, processability (e.g. ease of punching), etc.

The size of the waterproof cover disclosed herein is not particularly limited. For instance, in the waterproof cover having a PSA sheet laminated peripherally to a round waterproof membrane, the waterproof membrane's exposed region inside the PSA sheet may have a diameter (exposed diameter) of, for instance, about 0.2 mm to 50 mm, about 0.2 mm to 30 mm, about 0.5 mm to 20 mm, or even about 0.5 mm to 15 mm. In the waterproof cover exposed over such a diameter or over the corresponding area, the art disclosed herein can be applied to favorably obtain the effect to prevent wrinkling with aging. In the waterproof cover in this embodiment, the waterproof membrane may have an outer diameter of, for instance, about 2 mm to 52 mm, about 2 mm to 32 mm, about 2.5 mm to 22 mm, or even about 2.5 mm to 17 mm. The PSA layer (membrane-bonding PSA layer) that bonds the waterproof membrane and the PSA sheet placed on the waterproof cover's periphery can have a width in the range of, for instance, 0.3 mm or greater and 1.0 mm or less. From the standpoint of enhancing the effect to prevent wrinkling of the waterproof membrane, in some embodiments, the membrane-bonding PSA layer may have a width of, for instance, 0.5 mm or greater, 0.7 mm or greater, 1.0 mm or greater, 1.2 mm or greater, or even 1.5 mm or greater. From the standpoint of downsizing the waterproof cover, in some embodiments, the membrane-bonding PSA layer may have a thickness of, for instance, 5 mm or less, 3 mm or less, or even 2 mm or less.

In the art disclosed herein, a release liner can be used in forming the PSA layer; preparing the PSA sheet; storing, distributing and shape-machining the PSA sheet before laminated with waterproof membrane; fabricating the waterproof cover; and storing and distributing the waterproof cover when the waterproof cover has an exposed adhesive face (e.g. a substrate-free PSA sheet laminated on a waterproof membrane or the outer face of a substrate-supported double-faced PSA sheet), etc. The release liner is not particularly limited, and examples thereof include a release liner having a release-treated layer on the surface of a liner substrate such as a resin film or paper, and a release liner composed of a material with low adhesivity such as a fluoropolymer (polytetrafluoroethylene and the like) or a polyolefin resin (polyethylene, polypropylene, and the like). The release-treated layer can be formed, for example, by surface-treating the liner substrate with a release treatment agent such as a silicone-based, long-chain alkyl-based, fluorine-based agent, or molybdenum sulfide.

### <Waterproof Casing>

FIG. 4 shows an example of an electronic device using waterproof cover 20 shown in FIG. 3. The electronic device shown in FIG. 4 is a smartphone 40. Smartphone 40 has a housing (container) 52 inside which audio components 32 and 34 are placed as an example of the electronic device. Typical examples of audio components in a smartphone include a voice converter that carries out conversion between electrical signals and voices, such as speakers and microphones. Housing 52 has openings 53 and 54. Openings 53 and 54 are placed between voice converters and the outside. Two waterproof covers 20 individually have a waterproof membrane 12 which is a waterproof sound-permeable membrane (e.g. a porous PTFE membrane) and are attached to housing 52 with their second PSA layers 146 shown in FIG. 3 press-bonded from the inside of housing 52 to the peripheries of openings 53 and 54, thereby closing openings 53 and 54. Waterproof casing 50 is thus constituted, having housing 52 with openings 53 and 54, and waterproof covers 20 attached to housing 52 so as to close the openings 53 and 54. With audio components 32 and 34 housed inside, waterproof casing 50 constitutes smartphone 40 as an example of audio equipment. Waterproof covers 20 block foreign substances such as water and dust from entering the inside of housing 52 through openings 33 and 34. Sound to and/or from voice converters permeate waterproof membranes 12. A voice converter may be bonded to waterproof cover 20 via the second PSA layer 246 shown in FIG. 4. By this, waterproof cover 20 can also be used as a fixing member to fasten a voice converter to housing 52.

Examples of the electronic device are not limited to smartphones. The waterproof cover disclosed herein can be applied to waterproof casings constituting various electronic devices including communication equipment such as mobile phones and smartphones as well as information terminals such as tablet PCs, notebook PCs, calculators (electronic calculators, etc.), electronic notebooks and an e-book readers; information devices for vehicles; information terminals such as electronic dictionaries; IC recorders; digital cameras; gaining devices; mobile audios; home appliances with vocal guidance; various wearable devices (e.g. wrist wearable devices such as a wrist watch, modular devices worn on part of a body with a clip, a strap, or the like, eyewear type devices inclusive of eyeglasses type devices (monocular and binocular type; including head-mounted device), devices attached to clothing, for example, in the form of an accessory on a shirt, a sock, a hat, or the like, earwear type devices which are attached to the ear, such as an earphone); mobile radios, mobile televisions, mobile printers, mobile scanners, and mobile modems. Examples of a housing that may constitute a waterproof casing using the waterproof cover disclosed herein can widely include a package with a microphone; housings that include electronic circuit boards such as vehicle ECUs (electrical control units) and solar cell controller boards, driving components such as motors, light sources such as lamps for automobiles and other vehicles, power sources such as batteries, sensors and other electronic components; and housings for home appliance such as electric toothbrushes and shavers. The waterproof cover disclosed herein can be preferably used as a component of a waterproof casing that is used to house, store, transport, etc., not only electronic devices, but also, for instance, items desired to be waterproof such as clothes and paper products; and items requiring water containment such as food, living species and wet clothes.

The matters disclosed by this description include the following:
(1) A waterproof cover having

a waterproof membrane, and

a PSA sheet laminated peripherally to the waterproof membrane, wherein

the PSA sheet includes a PSA layer bonded to the waterproof membrane, and

the PSA layer is formed of a PSA having a storage modulus Gr′ of 53000 Pa or higher at 40° C.
(2) The waterproof cover according to (1) above, wherein the PSA is crosslinked with an epoxy-based crosslinking agent.
(3) The waterproof cover according to (1) or (2) above, wherein the PSA is crosslinked with an isocyanate-based crosslinking agent.
(4) The waterproof cover according to any of (1) to (3) above, wherein the PSA has a gel fraction of 35% or higher.
(5) The waterproof cover according to any of (1) to (4) above, wherein the PSA is an acrylic PSA comprising an acrylic polymer as base polymer.
(6) The waterproof cover according to (5) above, wherein the acrylic polymer is a polymer of a monomer mixture including at least 75% C₁₋₄ alkyl (meth)acrylate by weight.
(7) The waterproof cover according to any of (1) to (8) above, wherein the PSA comprises a tackifier.
(8) The waterproof cover according to (7) above, comprising, as the tackifier, one, two or more species of tackifier resin selected from the group consisting of a phenolic tackifier resin, terpene-based tackifier resin, modified terpene-based tackifier resin, rosin-based tackifier resin and hydrocarbon-based tackifier resin.
(9) The waterproof cover according to (7) or (8) above, comprising an acrylic oligomer having a Tg of 0° C. or higher as the tackifier.
(10) The waterproof cover according to any of (7) to (9) above, wherein the tackifier content is 5 parts by weight or greater and less than 40 parts by weight to 100 parts by weight of the base polymer in the PSA layer.
(11) The waterproof cover according to any of (1) to (10) above, wherein the PSA has a storage modulus G′ of 20000 Pa or higher at 80° C.
(12) The waterproof cover according to any of (1) to (11) above, wherein the PSA layer has a thickness of less than 25 μm.
(13) The waterproof cover according to any of (1) to (12) above, wherein the waterproof membrane is formed of PTFE.
(14) The waterproof cover according to any of (1) to (13) above, wherein the waterproof membrane has a thickness of 10 μm or less.
(15) The waterproof cover according to any of (1) to (14) above, wherein the PSA sheet shows a displacement of 0.4 mm/h or less in a holding power test carried out at 80° C.
(16) The waterproof cover according to any of (1) to (15) above, wherein the PSA sheet is an adhesively double-faced substrate-supported PSA sheet having a substrate with first and second faces, the PSA layer as an inner PSA layer placed on the first face, and an outer PSA layer placed on the second face.
(17) The waterproof cover according to (16) above, wherein the substrate is a resin film.
(18) The waterproof cover according to any of (1) to (15) above, wherein the PSA sheet is a substrate-free PSA sheet formed of the PSA layer.
(19) The waterproof cover according to any of (1) to (18) above, wherein the waterproof membrane is exposed over an area corresponding to a circle of 0.2 mm to 50 mm in diameter inside the region laminated with the PSA sheet.
(20) The waterproof cover according to any of (1) to (19) above, wherein the waterproof membrane has a round shape in a planar view and the waterproof membrane has an outer diameter in the range between 2 mm and 52 mm.
(21) The waterproof cover according to any of (1) to (20) above, wherein the PSA layer has a width of 0.5 mm or greater and 5 mm or less.
(22) The waterproof cover according to any of (1) to (21) above, having

the PSA sheet as a first PSA sheet laminated peripherally on a first face of the waterproof membrane, and

a second PSA sheet laminated peripherally on a second face of the waterproof membrane.
(23) A waterproof casing having

a container having an opening, and

the waterproof cover according to any of (1) to (22) attached to the container to close the opening.
(24) An electronic device having

a container having an opening,

an electronic component housed in the container, and

the waterproof cover according to any of (1) to (22) attached to the container to close the opening.
(25) The electronic device according to (24), wherein the electronic component is an audio component.

### EXAMPLES

Several working examples related to the present invention are described below, but the present invention is not intended to be limited to these examples. In the description below, “parts” and “%” are by weight unless otherwise specified.

### <Preparation of PSA Compositions>

### (PSA Composition A1)

Into a reaction vessel equipped with a stirrer, thermometer, nitrogen inlet, reflux condenser and addition funnel, were placed 95 parts of BA and 5 parts of AA as monomers, 0.2 part of AIBN as polymerization initiator, and ethyl acetate as polymerization solvent. Under a nitrogen flow, solution polymerization was carried out at 60° C. for 8 hours to obtain an acrylic polymer solution. The acrylic polymer's Mw was about 60×10⁴.

To the acrylic polymer solution, per 100 parts of acrylic polymer in the solution, were added 25 parts of an acrylic oligomer as a tackifier, 1 part of an isocyanate-based crosslinking agent (product name CORONATE L, 75% solution of trimethylol propane/tolylene diisocyanate trimer adduct in ethyl acetate, available from Tosoh Corporation) and 0.075 part of an epoxy-based crosslinking agent (product name TETRAD-C, 1,3-bis(N,N-diglycidylaminomethyl)cyclohexane, available from Mitsubishi Gas Chemical Co., Ltd.) as crosslinking agents. The resultant was mixed with stirring to prepare PSA composition A1.

The acrylic oligomer used was prepared by the following method: Into a reaction vessel equipped with a stirrer, thermometer, nitrogen inlet, reflux condenser and addition funnel, were placed 95 parts of CHMA and 5 parts of AA as well as 10 parts of AIBN as polymerization initiator and toluene as polymerization solvent. Under a nitrogen flow, solution polymerization was carried out at 85° C. for five hours to obtain an acrylic oligomer having a Mw of about 3600.

### (PSA Composition A2)

In the preparation of the PSA composition A1, in place of the acrylic oligomer, was used 30 parts of a terpene phenol resin (product name YS POLYSTAR S-145, available from Yasuhara Chemical Co., Ltd.; softening point ˜145° C; hydroxyl value: 70-110 mgKOH/g); and the amounts of isocyanate-based crosslinking and epoxy based crosslinking agent used were changed to 2 parts and 0.01 part, respectively. Otherwise in the same manner as the preparation of PSA composition A1, was prepared PSA composition A2.

### (PSA Composition A3)

Into a reaction vessel equipped with a stirrer, thermometer, nitrogen inlet, reflux condenser and addition funnel, were placed 70 parts of BA, 30 parts of 2EHA, 3 parts of AA and 0.05 part of 4-hydroxybutyl acrylate (4HBA) as monomers; 0.35 part of AIBN as polymerization initiator, and ethyl acetate as polymerization solvent. Under a nitrogen flow, solution polymerization was carried out at 65° C. for 3.5 hours to obtain an acrylic polymer solution.

To the acrylic polymer solution, per 100 parts of acrylic polymer in the solution, were added 30 parts of a polymerized rosin ester (trade name PENSEL D125 available from Arakawa Chemical Industries, Ltd.; softening point 125° C.) and 2 parts of an isocyanate-based crosslinking agent (product name TAKENATE L available from Mitsui Chemicals, Inc.). The resultant was mixed with stirring to prepare PSA composition A3a.

The amount of isocyanate-based crosslinking agent was also changed to 3 parts. Otherwise in the same manner as the preparation of PSA composition A3a, was prepared PSA composition A3b.

### (PSA Composition A4)

Into a reaction vessel equipped with a stirrer, thermometer, nitrogen inlet, reflux condenser and addition funnel, were placed 100 parts of BA, 5 parts of vinyl acetate (VAc), 3 parts of AA and 0.1 part of 2-hydroxyethyl acrylate (HEA) as monomers; 0.3 part of AIBN as polymerization initiator, and toluene as polymerization solvent. Solution polymerization was carried out at 60° C. for 6 hours to obtain an acrylic polymer solution. The acrylic polymer's Mw was about 55×10⁴.

To the acrylic polymer solution, per 100 parts of acrylic polymer in the solution, were added 40 parts of tackifier resins and 2 parts of an isocyanate-based crosslinking agent (product name CORONATE L available from Tosoh Corporation). The resultant was mixed with stirring to prepare PSA composition A4.

As the tackifier resins, were used 10 parts of a polymerized rosier ester with ˜125° C. softening point (product name HARITACK PCJ available from Harima Chemicals Group, Inc.), 10 parts of a stabilized rosin ester with ˜80° C. softening point (product name HARITACK SE10 available from Harima Chemicals Group, Inc.), 5 parts of a hydrogenated rosin methyl ester (product name M-HDR available from Wuzhou Sun Shine Forestry and Chemicals Co., Ltd. of Guangxi; as liquid) and 15 parts of a terpene phenol resin with ˜133° C. softening point (product name SUMILITE RESIN PR-12603 available from Sumitomo Bakelite Co., Ltd.).

### (PSA Composition A5)

Into a reaction vessel equipped with a stirrer, thermometer, nitrogen inlet, reflux condenser and addition funnel, were placed 90 parts of 2EHA and 10 parts of AA as monomers as well as 199 parts of ethyl acetate as polymerization solvent. Under a nitrogen flow, the resulting mixture was allowed to stir for 2 hours. After oxygen was thus removed from the polymerization system, was added 0.2 part of benzoyl peroxide as polymerization initiator and solution polymerization was carried out at 60° C. for 6 hours to obtain an acrylic polymer solution. The acrylic polymer's Mw was about 120×10⁴.

To the acrylic polymer solution, per 100 parts of acrylic polymer in the solution, was added 0.175 part of an epoxy-based crosslinking agent (product name TETRAD-C, 1,3-bis(N,N-diglycidylaminomethyl)cyclohexane, available from Mitsubishi Gas Chemical Co., Ltd.). The resultant was mixed with stirring to prepare PSA composition A5.

### (PSA Composition A6)

In the preparation of the PSA composition A5, the amount of epoxy-based crosslinking agent used was changed to 0.05 part; and per 100 parts of acrylic polymer in the acrylic polymer solution, was further added 20 parts of terpene phenol resin (product name YS POLYSTAR S145, available from Yasuhara Chemical Co., Ltd.; softening point ˜1.45° C.; hydroxyl value: 70-110 mgKOH/g). Otherwise in the same manner as the preparation of PSA composition A5, was prepared PSA composition A6.

### <Preparation of Waterproof Membrane >

To a PTFE dispersion (40 wt % PTFE powder (0.2 μm mean particle diameter), containing 6 parts of nonionic surfactant per 100 parts of PTFE), was added 1 part of a fluorosurfactant (MEGAFACE F-142D available from DIC Corporation) to 100 parts of PTFE in the dispersion. Along strip of polyimide film (125 μm thick) was then immersed in and removed from the PTFE dispersion to form a coating film of the PTFE dispersion on the film. For this, using a measuring bar, the coating film was formed 20 μm thick. The coating film was then heated at 100° C. for one minute and subsequently at 390° C. for one minute to vaporize and remove water from the dispersion while binding the remaining PTFE particles together to obtain a PTFE film. The immersion and heating were repeated two more times and the resulting PTFE film (25 μm thick) was separated from the polyimide film.

Using a roller rolling machine, the resulting PTFE film was rolled in MD at a rolling ratio value of 2.5. The roller temperature setting of the roller rolling machine ways 170° C. Subsequently, the rolled PTFE film was stretched in TD with a tenter at a stretch ratio value of 2. The stretching temperature was 170° C. A porous PTFE film was thus obtained, having a thickness of 8 μm, a surface density of 13.0 g/m², and an air permeability of 68 s/100 mL. In the waterproof cover preparation described later, this porous PTFE film was used as the waterproof membrane.

### <Preparation of PSA Sheets>

### (PSA Sheet S1)

Were obtained two sheets of commercial release liner formed of polyester film with one face subjected to release treatment. To the release face of each release liner, was applied PSA composition A1 and allowed to dry at 100° C. for 2 minutes to form a 13 μm thick PSA layer. To the first and second faces of 4 μm thick polyethylene terephthalate (PET) film as a substrate, were adhered the PSA layers on the respective release liners to prepare substrate-supported double-faced PSA sheet S1 having PSA layers on the first and second faces of PET film and measuring 30 μm in overall thickness. The first and second adhesive faces of the PSA sheet are protected with the two release liners.

### (PSA Sheets S2 to S9)

The PSA composition, substrate and its thickness and the PSA layer's thickness used were changed as shown in Table 2. Otherwise in the same manner as the preparation of PSA sheet S1, were prepared PSA sheets S2 to S9. In PSA sheets S2 to S8, as their substrates, were used PET films having thicknesses shown in Table 2. In PSA sheet S9, as the substrate, was used a black polyethylene foam sheet (expansion ratio value of 3) having the thickness shown in Table 2.

### (PSA Sheet S10)

Were obtained two sheets of commercial release liner formed of polyester film with one face subjected to release treatment. To the release face of the first release liner, was applied PSA composition A5 and allowed to dry at 100° C. for 2 minutes to form a 50 μm thick PSA layer. To the surface of this PSA layer, was adhered the second release liner. Substrate-free PSA sheet S10 formed of the PSA layer was thus obtained. The two faces of PSA sheet S10 are protected with the two release liners.

### (PSA Sheet S11)

Were obtained two sheets of commercial release liner formed of polyester film with one face subjected to release treatment. To the release face of each release liner, was applied PSA composition A6 and allowed to dry at 100° C. for 2 minutes to form a 25 μm thick PSA layer. To the first and second faces of 50 μm thick polyimide (PI) film as a substrate, were adhered the PSA layers on the respective release liners to prepare substrate-supported double-faced PSA sheet S11 having PSA layers on the first and second faces of PI film and measuring 100 μm in overall thickness. The first and second adhesive faces of the PSA sheet are protected with the two release liners.

### <Preparation of Waterproof Covers>

Using the waterproof membrane and PSA sheets S1to S11, were prepared 50 samples (number of samples N=50) for each of waterproof covers according to Examples 1 to 11. In particular, were obtained two sheets for each of PSA sheets S1 to S11. In each of the two PSA sheets, 50 holes of 2.5 mm in diameter were punched at constant intervals (5 holes×10 rows) and their first adhesive faces were adhered to the first and second faces of the waterproof membrane. The resultant was punched along outer circumferences to prepare waterproof cover samples 60, each having a round waterproof membrane of 6.0 mm in diameter with its first and second faces 12A and 12B laminated peripherally with annular PSA sheets 14 and 24 having inner and outer diameters of 2.5 mm and 6.0 mm. Each sample 60 has the same constitution as waterproof cover 20 shown in FIG. 3. In the 50 samples 60 according to each Example, their first adhesive faces 60A are protected with one sheet of release liner 62 shared among them. The second adhesive face 60B of each sample 60 is protected with a release liner 64 having the same annular shape as PSA sheets 14 and 24. Inside the inner circumferences of PSA sheets 14 and 24, waterproof membrane 12 is exposed over a round area of 2.5 mm in diameter. Immediately after the preparation of waterproof covers of Examples 1 to 11, the number of samples found with waterproof membrane wrinkles among the 50 waterproof cover samples was zero in all Examples.

### <Measurements and Evaluations>

### (Storage Moduli G′)

With respect to the PSA formed from each PSA composition, the 40° C. storage modulus G′ and 80° C. storage modulus G′ were determined by the methods described above. The results are shown in Table 1.

### (Gel Fraction)

With respect to the PSA formed from each PSA composition, the gel fraction was determined by the method described above. As a result, the PSA formed from PSA compositions A1, A2 and A6 all had gel fractions of 40% or higher (50% to 60%. The PSA formed from PSA composition A5 had a gel fraction of about 80%. The PSA formed from PSA compositions A3a, A3b and A4 all had gel fractions below 35%.

### (Holding Power Test)

PSA sheets S1 to S11 were subjected to holding power tests at 40° C. and 80° C.

### [80° C. Holding Power Test]

In an environment at 23° C. and 50% RH, to the second adhesive face of a PSA sheet, was adhered a 50 μm thick PET film as a backing. The resultant was cut 10 mm wide to prepare a measurement sample. The first adhesive face of the measurement sample was adhered to a phenol resin plate as an adherend with a 2 kg roller moved back and forth once over a 10 mm wide, 20 mm long bonding area. The measurement sample adhered to the adherend in this way was vertically suspended in an environment at 80° C. and left for 30 minutes. Subsequently, a 500 g load was applied to the free end of the measurement sample. After left for 1 hour in the environment at 80° C. with the applied load, the measurement sample was measured for the displaced distance (mm) from the initial location of adhesion. For the PSA sheet according to each Example, the test was carried out with three measurement samples (i.e. N =3). Table 1 shows the arithmetic average value of their displaced distances.

### [40° C. Holding Power Test]

The temperature of the environment for vertically suspending the measurement sample and leaving it for one hour with the applied 500 g load was changed to 40° C. Otherwise in the same manner as the 80° C. holding power test, a 40° C. holding power test was carried out. With respect to the PSA sheet according to each Example, the test was carried out with three measurement samples (i.e. N=3). Table 1 shows the arithmetic average value of their displaced distances.

### (Occurrence of Wrinkling)

Waterproof cover samples according to each Example were stored in an environment at 23° C. and 50% RH for three days. Subsequently, the waterproof cover samples were visually inspected for the presence of wrinkles in the waterproof membrane exposed inside the PSA sheet's inner circumference. As a result, among the 50 waterproof cover samples for each, when even one sample was found with wrinkles, the occurrence of wrinkling was judged “Present”; when all samples were wrinkle-free, the occurrence of wrinkling was judged “Absent.” The results are shown in Table 1.

(Determination of to-PTFE Peel Strength)

In a measurement environment at 23° C. and 50% RH, to the second adhesive faces of PSA sheets S2, S4 and S7, were adhered 25 μm thick PET films for backing. The resultants were cut 20 mm wide and 100 mm long to prepare measurement samples. With respect to the first adhesive face of each measurement sample, using the waterproof membrane prepared above as the adherend, the to-PTFE peel strength (N/20 mm) was determined by the aforementioned method. As a result, PSA sheet S2 had a to-PTFE peel strength of 4.4 N/20 mm, PSA sheet S4 4.8 N/20 mm, and PSA sheet S7 6.3 N/20 mm, with all being at least 2.0 N/20 mm.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|
| PSA composition | | A1 | | | A2 | | A3a | A3b | | A4 | A5 | A6 |
| Storage | 40° C. | 138 | | | 115.5 | | 51.2 | 52.8 | | 52.4 | 91 | 92 |
| modulus G' | 80° C. | 68.6 | | | 49.1 | | 18.9 | 19.7 | | 21.6 | 49.2 | 37 |
| (kPa) | | | | | | | | | | | | |
| Substrate | | PET | PET | PET | PET | PET | PET | PET | PET | Foam | — | PI |
| PSA sheet | | S1 | S2 | S3 | S4 | S5 | S6 | S7 | S8 | S9 | S10 | S11 |
| Constitution | 1st PSA layer | 13 | 19 | 37.5 | 19 | 37.5 | 13 | 19 | 37.5 | 25 | — | 25 |
| (μm) | Substrate | 4 | 12 | 25 | 12 | 75 | 4 | 12 | 75 | 150 | — | 50 |
| | 2nd PSA layer | 13 | 19 | 37.5 | 19 | 37.5 | 13 | 19 | 37.5 | 25 | — | 25 |
| | Overall thickness | 30 | 50 | 100 | 50 | 150 | 30 | 50 | 150 | 200 | 50 | 100 |
| Holding power | 40° C. | 0.1 | 0.1 | 0.1 | 0.1 | 0.1 | 0.3 | 0.3 | 0.3 | 0.3 | 0.1 | 0.1 |
| (mm/h) | 80° C. | 0.1 | 0.1 | 0.1 | 0.2 | 0.2 | 0.5 | 0.5 | 0.5 | 0.5 | 0.2 | 0.2 |

| | | | | | | | | | | | |
|---|---|---|---|---|---|---|---|---|---|---|---|
| Occurrence of wrinkling | Absent | Absent | Absent | Absent | Absent | Present | Present | Present | Present | Absent | Absent |

As shown in Table 1, in the waterproof covers of Examples 1 to 5, 10 and 11 in which the PSA bonding the waterproof membrane and the PSA sheet had a 40° C. storage modulus G′ of 53000 Pa or higher (i.e. 53.0 kPa or higher), wrinkling of waterproof membrane with aging was inhibited in comparison with the waterproof covers of Examples 6 to 9.

Although specific embodiments of the present invention have been described in detail above, these are merely for illustrations and do not limit the scope of claims. The art according to the claims includes various modifications and changes made to the specific embodiments illustrated above.

### [Reference Signs List]

10, 20: waterproof covers
12: waterproof membrane
12A: first surface
12B: second surface
14, 24: PSA sheets
32, 34: audio components
40: smartphone (electronic device)
50: waterproof casing
52: housing (container)
53, 54: openings
60: waterproof cover sample
62, 64: release liners
142, 242: substrates
142A, 242A: first faces (waterproof membrane side surface)
142B, 242B: second faces (outer surface)
144, 244: first PSA layers (inner PSA layers, membrane-bonding PSA layers)
146, 246: second PSA layers (outer PSA layers)

1. A waterproof cover having
a waterproof membrane, and
a pressure-sensitive adhesive sheet laminated peripherally to the waterproof membrane, wherein
the pressure-sensitive adhesive sheet comprises a pressure-sensitive adhesive layer bonded to the waterproof membrane, and
the pressure-sensitive adhesive layer is formed of a pressure-sensitive adhesive having a storage modulus G′ of 53000 Pa or higher at 40° C.

2. The waterproof cover according to claim 1, wherein the pressure-sensitive adhesive is crosslinked with an epoxy-based crosslinking agent.

3. The waterproof cover according to claim 1, wherein the pressure-sensitive adhesive has a gel fraction of 35% or higher.

4. The waterproof cover according to claim 1, wherein the pressure-sensitive adhesive is an acrylic pressure-sensitive adhesive comprising an acrylic polymer as base polymer.

5. The waterproof cover according to claim 1, wherein the pressure-sensitive adhesive comprises a tackifier.

6. The waterproof cover according to claim 1, wherein the pressure-sensitive adhesive sheet shows a displacement of 0.4 mm/h or less in a holding power test carried out at 80° C.

7. The waterproof cover according to claim 1, wherein the pressure-sensitive adhesive sheet is an adhesively double-faced substrate-supported pressure-sensitive adhesive sheet having a substrate with first and second faces, the pressure-sensitive adhesive layer as an inner pressure-sensitive adhesive layer placed on the first face, and an outer pressure-sensitive adhesive layer placed on the second face.

8. The waterproof cover according to claim 7, wherein the substrate is a resin film.

9. A waterproof casing having
a container having an opening, and
the waterproof cover according to claim 1 attached to the container to close the opening.

10. An electronic device having
a container having an opening,
an electronic component housed in the container, and
the waterproof cover according to claim 1 attached to the container to close the opening.
